(19) United States
(12) Patent Application Publication
(10) Pub. No.: US 2026/0072379 A1
(43) Pub. Date: Mar. 12, 2026

(54) CARTRIDGE

(71) Applicant: CANON KABUSHIKI KAISHA, Tokyo (JP)

(72) Inventors: AKINORI MITSUMATA, Tokyo (JP); TOMOHIRO SUZUKI, Chiba (JP)

(21) Appl. No.: 19/323,061

(22) Filed: Sep. 9, 2025

(30) Foreign Application Priority Data
Sep. 12, 2024 (JP) 2024-158000

(51) Int. Cl. G03G 15/08

(52) U.S. Cl. CPC G03G 15/0881; G03G 15/0875; G03G 15/0879

(57) ABSTRACT

A cartridge for storing toner includes a frame having a chamber opening that allows toner to move from the inside to the outside of the cartridge and an air chamber opening that allows air to move from the outside to the inside of the cartridge, a filter that partitions a space into an air chamber that receives air via the air chamber opening and a toner storage chamber, the filter being fixed to the frame and allowing passage of air while restricting passage of toner, and a pipe disposed in the toner storage chamber, the pipe having a first opening that receives toner from the toner storage chamber and a second opening connected to the chamber opening. The air chamber is provided below the toner storage chamber in the direction of gravity.

### BACKGROUND

### Field of the Technology

The present disclosure relates to a cartridge.

### Description of the Related Art

Generally, an electrophotographic image forming apparatus forms an image by transferring a toner image formed on the surface of a photosensitive drum onto a transfer material as a transfer medium. As methods for replenishing developer, a process cartridge system and a toner replenishment system are known, for example. The process cartridge system is a system in which a photosensitive drum and a developing container are integrated as a process cartridge, and the process cartridge is replaced with a new one when the developer is depleted. On the other hand, in the toner replenishment system, when the toner is depleted, new toner is supplied to the developing container. Conventionally, an image forming apparatus has been proposed in which toner is supplied to a developing container using a toner pack that is detachably attached to the developing container (Japanese Patent Application Laid-Open No. 2020-154300).

Also, there has been proposed an image forming apparatus including a developing device for storing toner, a toner container for storing toner to be supplied to the developing device, and an air pump for sending air to the toner container (Japanese Patent Application Laid-Open No. 2000-147884). This image forming apparatus is provided with an air filter that allows only air, among the toner and air sent from the toner container to the developing device, to be vented to the outside of the developing device.

### SUMMARY

The present disclosure provides a cartridge configured to be attachable to an apparatus body of an image forming apparatus and to store toner, comprising: a frame that forms an internal space, the frame having a chamber opening that allows toner to move from an inside to an outside of the cartridge and an air chamber opening that allows air to move from the outside to the inside of the cartridge; a filter that partitions the internal space into an air chamber that receives air via the air chamber opening and a toner storage chamber that stores toner, the filter being fixed to the frame and allowing passage of air while restricting passage of the toner; and a pipe disposed inside the toner storage chamber, the pipe having a first opening that receives toner stored in the toner storage chamber and a second opening connected to the chamber opening, the pipe allowing toner to pass from the first opening to the second opening, wherein when the cartridge is in an attachment posture for attachment to the image forming apparatus, the air chamber is provided below the toner storage chamber in the direction of gravity, and an end surface forming the first opening of the pipe has a first region that contacts the filter positioned below the pipe and a second region that does not contact the filter.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic overall view showing an image forming apparatus according to a first embodiment;

FIG. 2A is a perspective view showing the image forming apparatus;

FIG. 2B is a perspective view showing the image forming apparatus with the front door open;

FIG. 2C is a perspective view showing the image forming apparatus with the toner cartridge removed;

FIG. 3A is a perspective view showing an image forming unit;

FIG. 3B is a perspective view showing the image forming unit with the toner cartridge removed;

FIG. 4 is a perspective view showing an optical path of a laser beam emitted from a laser scanner;

FIG. 5A is a plan view showing the laser scanner and the image forming unit;

FIG. 5B is a plan view showing the image forming unit;

FIG. 6A is a cross-sectional view taken along line 6A-6A of FIG. 5B;

FIG. 6B is a cross-sectional view taken along line 6B-6B of FIG. 5B;

FIG. 7A is a cross-sectional view taken along line 7A-7A of FIG. 5A;

FIG. 7B is an enlarged cross-sectional view showing a supply pipe;

FIG. 8 is a perspective view showing a state in which the image forming unit is pulled out from an apparatus body;

FIGS. 9A to 9E are views of a toner cartridge;

FIG. 10A is a cross-sectional view taken along line 10A-10A of FIG. 9B;

FIG. 10B is a perspective view of FIG. 10A;

FIG. 10C is an exploded view of FIG. 10A;

FIG. 10D is an exploded perspective view showing the toner cartridge;

FIG. 11A is a partially enlarged view of View 11A, and FIG. 11B is a partially enlarged view of View 11B;

FIG. 12A is a cross-sectional view taken along line 12A-12A of FIG. 9E, showing a discharge pipe;

FIG. 12B is a perspective view of FIG. 12A;

FIGS. 13A and 13B are cross-sectional views showing a variation of the toner cartridge;

FIGS. 14A and 14B are cross-sectional views showing another variation of the toner cartridge;

FIGS. 15A and 15B are cross-sectional views showing yet another variation of the toner cartridge;

FIGS. 16A and 16B are views of a toner cartridge and a discharge pipe according to another embodiment;

FIGS. 17A and 17B are views of a toner cartridge and a discharge pipe according to another embodiment;

FIGS. 18A and 18B are views of a toner cartridge and a discharge pipe according to another embodiment;

FIGS. 19A and 19B are views showing a toner cartridge according to another embodiment;

FIGS. 20A and 20B are views showing a toner cartridge according to another embodiment; and

FIGS. 21A and 21B are views showing a toner cartridge according to another embodiment.

### DESCRIPTION OF THE EMBODIMENTS

Embodiments of the present disclosure will now be described with reference to the accompanying drawings. However, it is to be understood that dimensions, materials, shapes, relative arrangements, and the like of components described in the embodiments are intended to be changed as appropriate in accordance with configurations and various conditions of apparatuses to which the disclosure is to be applied. Therefore, unless otherwise specified, the scope of the present disclosure is not intended to be limited thereto. While a plurality of features are described in each of the embodiments, all the features are not necessarily essential to the disclosure and the plurality of features may be combined with each other in any way.

The present disclosure provides a preferred embodiment of a cartridge for storing toner used in an image forming apparatus, the cartridge being provided with a filter.

### First Embodiment

### Overall Configuration

First, a first embodiment of the present disclosure will be described. An image forming apparatus 1 according to the first embodiment is an electrophotographic laser beam printer. Here, the term “image forming apparatus” refers to an apparatus that forms an image on a sheet used as a recording medium based on image information input from an external PC or image information read from an original document, and examples thereof include a printer, a copier, a facsimile machine, and a multifunction device. In addition to the main body having an image forming function, the image forming apparatus may be connected to peripheral devices such as an optional feeder, an image reading device, and a sheet processing device, and the entire system with such peripheral devices connected is also a type of image forming apparatus.

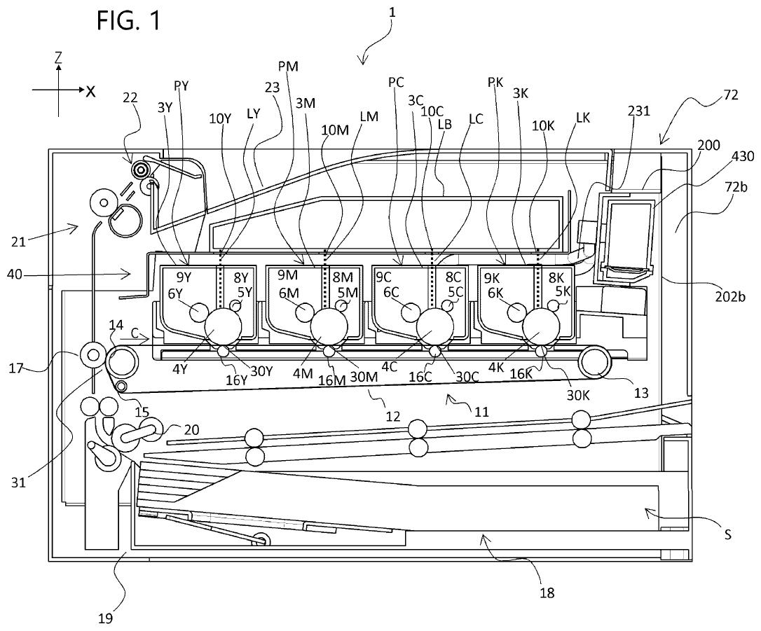

As shown in FIG. 1, the image forming apparatus 1 includes an image forming section 40 for forming an image on a sheet S, a feed unit 18, a fixing unit 21, and a discharge roller pair 22. The image forming section 40 includes four process cartridges PY, PM, PC, and PK for forming toner images in four colors, yellow (Y), magenta (M), cyan (C), and black (K), respectively, and a laser scanner LB. The laser scanner LB is disposed above the process cartridges PY, PM, PC, and PK. An LED exposure unit may be used in place of the laser scanner LB.

The portion of the image forming apparatus 1 excluding the process cartridges PY, PM, PC, and PK and the toner cartridges 430Y, 430M, 430C, and 430K described later may be referred to as a main body or an apparatus body 72 of the image forming apparatus 1. Note that in the following description, the toner cartridges 430Y, 430M, 430C, and 430K may be simply referred to as cartridges 430Y, 430M, 430C, and 430K. The process cartridges PY, PM, PC, and PK may be detachably supported on the apparatus body 72, or may be fixed to the apparatus body 72.

In the present embodiment, parts corresponding to yellow, magenta, cyan, and black toners are denoted with subscripts P, Y, M, C, and K. The configuration and operation of the parts denoted with these subscripts are substantially the same except for the color of the toner. Therefore, unless it is necessary to distinguish them, the following description may be made collectively by omitting the subscripts Y to K.

In the following description, unless otherwise specified, it is assumed that the process cartridges PY, PM, PC, and PK and the toner cartridges 430Y, 430M, 430C, and 430K are in their normal posture, i.e., the posture when mounted to the apparatus body 72, and the directions (X, Y, Z) are defined as follows. Here, the terms “front/rear,” “top/bottom,” and “left/right” refer to the directions as viewed by a user standing in front of the image forming apparatus 1 so as to see the front side where an indicator 208 is located.

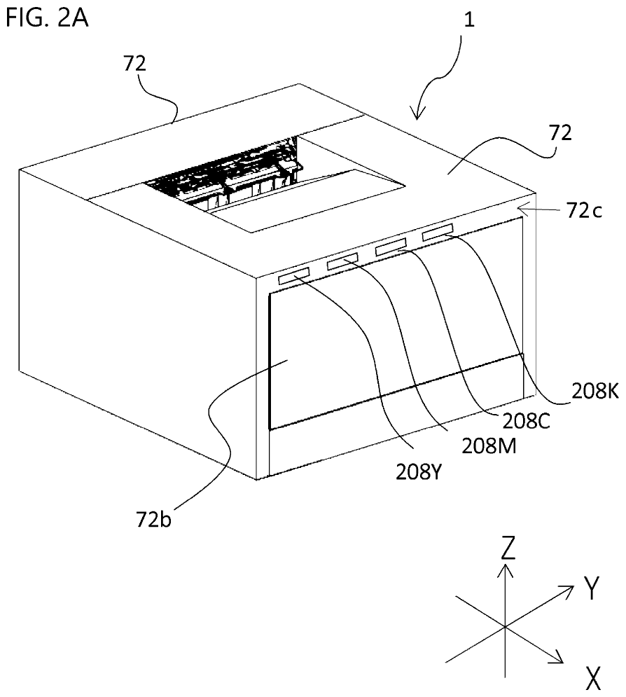

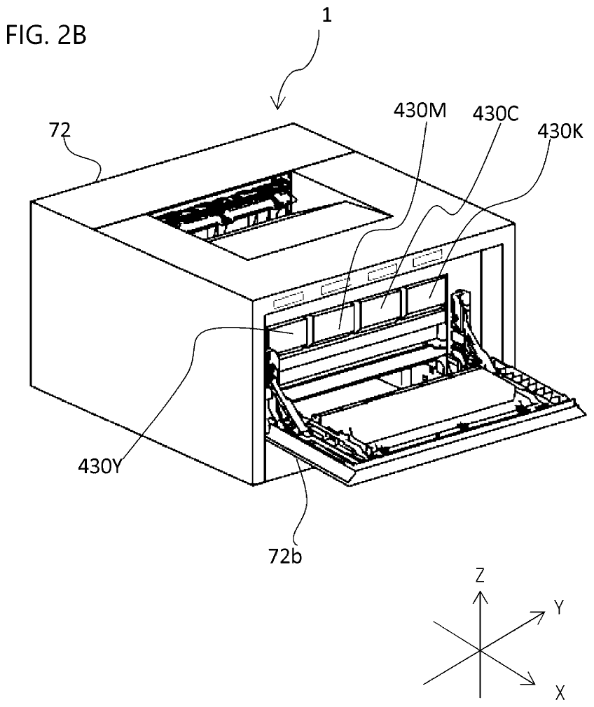

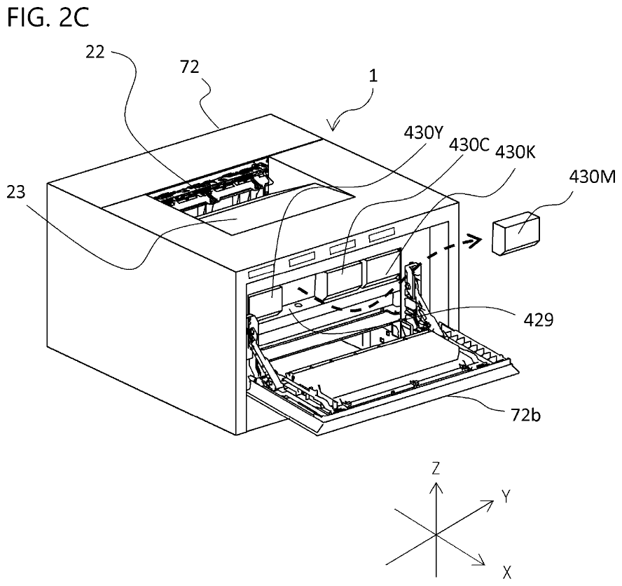

As shown in FIG. 2A, the front-rear direction is indicated by the X axis, and the direction from the rear to the front of the image forming apparatus 1 is defined as the X direction. The X direction may also be referred to as the forward direction or the frontward direction. Further, the downstream side in the X direction of the image forming apparatus 1 may be referred to as the front side, and the upstream side may be referred to as the rear side.

The left-right direction is indicated by the Y axis, and the direction from the left to the right of the image forming apparatus 1 is defined as the Y direction. The Y direction may also be referred to as the rightward direction. Further, the downstream side in the Y direction of the image forming apparatus 1 may be referred to as the right side, and the upstream side may be referred to as the left side.

The up-down direction is indicated by the Z axis, and the direction from the bottom to the top of the image forming apparatus 1 is defined as the Z direction. The Z direction may also be referred to as the upward direction, the height direction, or the vertical direction. Further, the downstream side in the Z direction of the image forming apparatus 1 may be referred to as the upper side, the top side, or the ceiling side, and the upstream side may be referred to as the lower side, the bottom side, or the floor side.

The X axis, Y axis, and Z axis are perpendicular to each other. For example, the X axis is perpendicular to the Y axis and also perpendicular to the Z axis. A plane perpendicular to the X axis may be referred to as the YZ plane, a plane perpendicular to the Y axis may be referred to as the ZX plane, and a plane perpendicular to the Z axis may be referred to as the XY plane. For example, the XY plane is a horizontal plane. The X direction and Y direction are directions along the horizontal XY plane, i.e., horizontal directions.

The process cartridge PY includes a drum unit 8Y and a developing unit 9Y. The drum unit 8Y includes a photosensitive drum 4Y and a charging roller 5Y. The photosensitive drum 4Y is formed by applying an organic photoconductive layer to the outer periphery of an aluminum cylinder and is rotated by a drive motor (not shown). A photosensitive belt may be used in place of the photosensitive drum 4Y. The developing unit 9Y includes a developing container 3Y storing yellow toner and a developing roller 6Y developing the electrostatic latent image on the photosensitive drum 4Y.

Similarly, the process cartridge PM includes a drum unit 8M and a developing unit 9M. The drum unit 8M includes a photosensitive drum 4M and a charging roller 5M. The photosensitive drum 4M is formed by applying an organic photoconductive layer to the outer periphery of an aluminum cylinder, and is rotated by a drive motor (not shown). A photosensitive belt may be used in place of the photosensitive drum 4M. The developing unit 9M includes a developing container 3M storing the magenta toner and a developing roller 6M developing the electrostatic latent image on the photosensitive drum 4M.

The process cartridge PC also includes a drum unit 8C and a developing unit 9C. The drum unit 8C includes a photosensitive drum 4C and a charging roller 5C. The photosensitive drum 4C is formed by applying an organic photoconductive layer to the outer periphery of an aluminum cylinder and is rotated by a drive motor (not shown). A photosensitive belt may be used in place of the photosensitive drum 4C. The developing unit 9C includes a developing container 3C storing cyan toner and a developing roller 6C developing the electrostatic latent image on a photosensitive drum 4C.

The process cartridge PK includes a drum unit 8K and a developing unit 9K. The drum unit 8K includes a photosensitive drum 4K and a charging roller 5K. The photosensitive drum 4K is constructed by applying an organic photoconductive layer to the outer periphery of an aluminum cylinder, and is rotated by a drive motor (not shown). A photosensitive belt may be used in place of the photosensitive drum 4K. The developing unit 9K includes a developing container 3K storing black toner and a developing roller 6K developing an electrostatic latent image on a photosensitive drum 4K.

These four process cartridges PY, PM, PC, and PK are arranged side by side in the X direction. Further, the image forming section 40 is provided with an intermediate transfer belt unit 11 disposed below the process cartridges PY, PM, PC, and PK. The intermediate transfer belt unit 11 includes an intermediate transfer belt 12 stretched around a drive roller 14, a tension roller 13, and an assist roller 15, and a secondary transfer roller 17. The intermediate transfer belt 12 is rotated clockwise in FIG. 1 by the drive roller 14. On the inner side of the intermediate transfer belt 12, primary transfer rollers 16Y, 16M, 16C, and 16K are provided.

The primary transfer rollers 16Y, 16M, 16C, and 16K are in contact with the photosensitive drums 4Y, 4M, 4C, and 4K, respectively, thereby forming primary transfer sections 30Y, 30M, 30C, and 30K. The secondary transfer roller 17 is arranged to oppose the drive roller 14 via the intermediate transfer belt 12. The secondary transfer roller 17 and the intermediate transfer belt 12 are in contact with each other, thereby forming a secondary transfer section 31.

The fixing unit 21 includes a fixing film 21a heated by a heater and a pressure roller 21b pressed against the fixing film 21a. The feed unit 18 is provided at the lower part of the image forming apparatus 1. The feed unit 18 includes a feed cassette 19 that can be pulled out from and attached to the apparatus body 72, and a feed roller 20 that feeds sheets S stored in the feed cassette 19. The feed unit 18 may also have a manual feed port for inserting sheets by hand. Here, “sheet” includes paper such as regular sheets and envelopes, plastic films such as overhead projector (OHP) sheets, and fabrics.

### Image Forming Operation

Next, the image forming operation of the image forming apparatus 1 constituted as described above will be explained. When an image signal is input from a computer (not shown) or the like to the laser scanner LB, the laser scanner LB emits laser beams LY, LM, LC, and LK corresponding to the image signal onto the photosensitive drums 4Y, 4M, 4C, and 4K, respectively.

At this time, the surface of the photosensitive drum 4Y has been uniformly charged to a predetermined polarity and potential in advance by the charging roller 5Y, and when the laser beam LY is emitted from the laser scanner LB, an electrostatic latent image is formed on the surface. The electrostatic latent image formed on the photosensitive drum 4Y is developed by the developing roller 6Y, thereby forming a yellow (Y) toner image on the photosensitive drum 4Y.

Similarly, magenta (M), cyan (C), and black (K) toner images are formed on the photosensitive drums 4M, 4C, and 4K, respectively. The toner images of each color formed on the respective photosensitive drums are transferred onto the intermediate transfer belt 12 by the primary transfer rollers 16Y, 16M, 16C, and 16K and are conveyed to the secondary transfer roller 17 by the intermediate transfer belt 12, which is rotated by the drive roller 14.

The image forming process for each color is performed at a timing such that the toner image is superimposed on the upstream toner image primarily transferred onto the intermediate transfer belt 12. After the toner images of each color are transferred onto the intermediate transfer belt 12, the toner remaining on the surface of each photosensitive drum is removed by a cleaning device (not shown).

In parallel with this image forming process, sheets S stored in the feed cassette 19 of the feed unit 18 or sheets supplied from the manual feed port are conveyed toward the secondary transfer section 31. In the secondary transfer section 31, the full-color toner image on the intermediate transfer belt 12 is transferred onto the sheet S by a secondary transfer bias applied to the secondary transfer roller 17. The sheet S onto which the toner image has been transferred is subjected to predetermined heat and pressure by the fixing film 21a and the pressure roller 21b of the fixing unit 21, thereby melting and fixing (fusing) the toner. The sheet S that has passed through the fixing unit 21 is discharged by the discharge roller pair 22 in the direction along the X direction and stacked on a discharge tray 23 provided at the upper part of the apparatus body 72.

### Overall Configuration of Toner Cartridge

Next, with reference to FIGS. 2A to 2C, an overall configuration of the toner cartridges 430Y, 430M, 430C, and 430K will be described. FIG. 2A is a perspective view showing the image forming apparatus 1, FIG. 2B is a perspective view showing the image forming apparatus 1 with the front door 72b open, and FIG. 2C is a perspective view showing the image forming apparatus 1 with the toner cartridge 430M removed.

As shown in FIG. 2A, the image forming apparatus 1 includes a front door 72b that is openably and closably supported relative to the housing of the apparatus body 72. As shown in FIGS. 2A and 2B, the front door 72b covers an opening 72a provided at the front of the apparatus body 72, i.e., at the downstream end in the X direction, when positioned at the closed position. As shown in FIG. 2B, the front door 72b opens the opening 72a of the apparatus body 72 when positioned at the open position. The front door 72b can maintain its posture at the open position.

As shown in FIG. 2B, when the front door 72b is opened from the closed position to the open position, the toner cartridges 430Y, 430M, 430C, and 430K are exposed to the outside of the image forming apparatus 1 through the opening 72a. Thus, the user can access the toner cartridges 430Y, 430M, 430C, and 430K. The toner cartridges 430Y, 430M, 430C, and 430K can supply toner to the developing containers 3Y, 3M, 3C, and 3K of the process cartridges PY, PM, PC, and PK.

The toner cartridges 430Y, 430M, 430C, and 430K are arranged at the downstream side in the X direction and the downstream side in the Z direction of the apparatus body 72, i.e., at the front side and the upper side of the apparatus body 72. In other words, the toner cartridges 430Y, 430M, 430C, and 430K are arranged at the downstream side of the apparatus body 72 in the sheet discharge direction of the discharge roller pair 22. Further, the toner cartridges 430Y, 430M, 430C, and 430K are arranged side by side in the Y direction. That is, the X direction, in which the process cartridges PY, PM, PC, and PK are arranged, and the Y direction, in which the toner cartridges 430Y, 430M, 430C, and 430K are arranged, intersect each other.

As shown in FIG. 2C, the toner cartridges 430Y, 430M, 430C, and 430K are detachably supported in the X direction by a cartridge holder 429 provided in the apparatus body 72. Therefore, the toner cartridges 430Y, 430M, 430C, and 430K can be replaced without removing the process cartridges PY, PM, PC, and PK from the apparatus body 72. Since the toner cartridges 430Y, 430M, 430C, and 430K are arranged at the front side of the apparatus body 72 and are exposed when the front door 72b is opened, they can be easily replaced.

The cartridge holder 429 is arranged at the front side of the apparatus body 72 and downstream of the process cartridges PY, PM, PC, and PK in the X direction. Therefore, even when the toner cartridges 430Y, 430M, 430C, and 430K are removed from the cartridge holder 429, the process cartridges PY, PM, PC, and PK are covered by the cartridge holder 429 and are not exposed to the outside of the image forming apparatus 1 through the opening 72a. The toner cartridges 430Y, 430M, 430C, and 430K are housed inside the apparatus body 72 when the front door 72b is in the closed position.

Further, as shown in FIG. 2A, indicators 208Y, 208M, 208C, and 208K are provided on the front surface 72c of the apparatus body 72. These indicators 208Y, 208M, 208C, and 208K are for clearly indicating to the user the color of the toner stored in the toner cartridges 430Y, 430M, 430C, and 430K. The indicators 208Y, 208M, 208C, and 208K are constituted by LEDs, seals, or the like. For example, the indicator 208Y is constituted by an LED that lights up or blinks in yellow, or by a seal colored in yellow. The indicators 208Y, 208M, 208C, and 208K may also be provided with a function for displaying the remaining amount of toner stored in the corresponding process cartridges PY, PM, PC, and PK.

In the present embodiment, the indicators 208Y, 208M, 208C, and 208K are provided on the front surface 72c of the apparatus body 72 and are not covered by the front door 72b in the closed position. That is, the indicators 208Y, 208M, 208C, and 208K are exposed to the outside of the image forming apparatus 1 regardless of the position of the front door 72b. However, for example, the indicators 208Y, 208M, 208C, and 208K may be arranged so as to be covered by the front door 72b in the closed position and exposed to the outside when the front door 72b is opened.

### Image Forming Unit

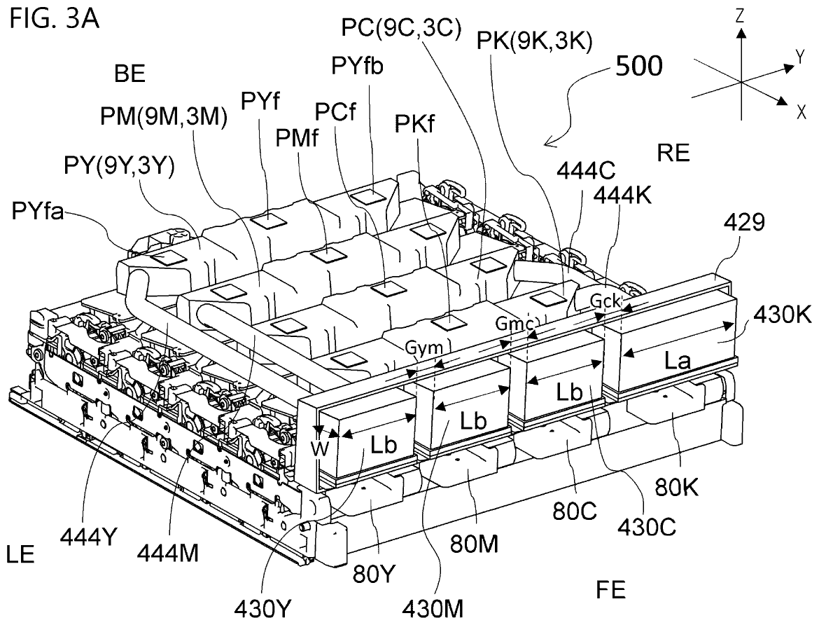

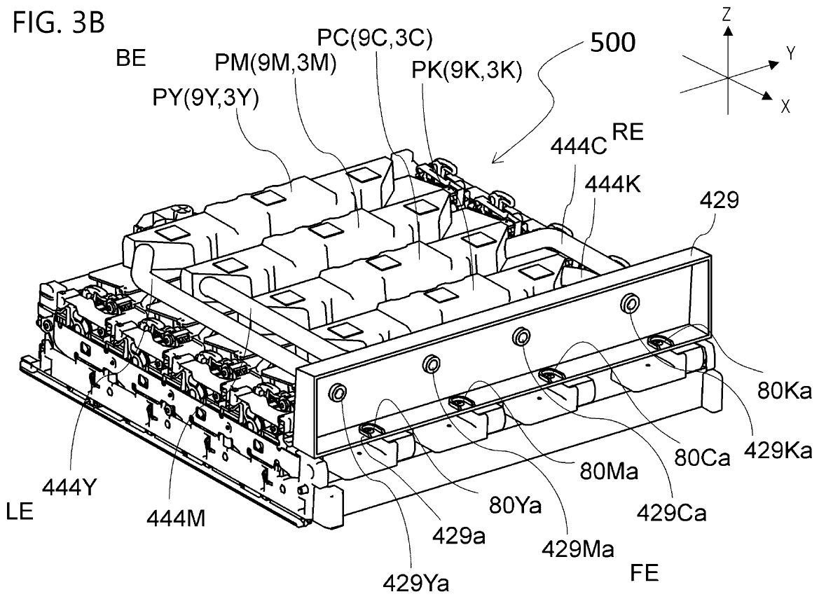

Next, with reference to FIGS. 3A and 3B to 8, an image forming unit 500 including a toner conveying mechanism for conveying toner from the toner cartridges 430Y, 430M, 430C, and 430K to the process cartridges PY, PM, PC, and PK will be described. FIG. 3A is a perspective view showing the image forming unit 500, and FIG. 3B is a perspective view showing the image forming unit 500 with the toner cartridges 430Y, 430M, 430C, and 430K removed.

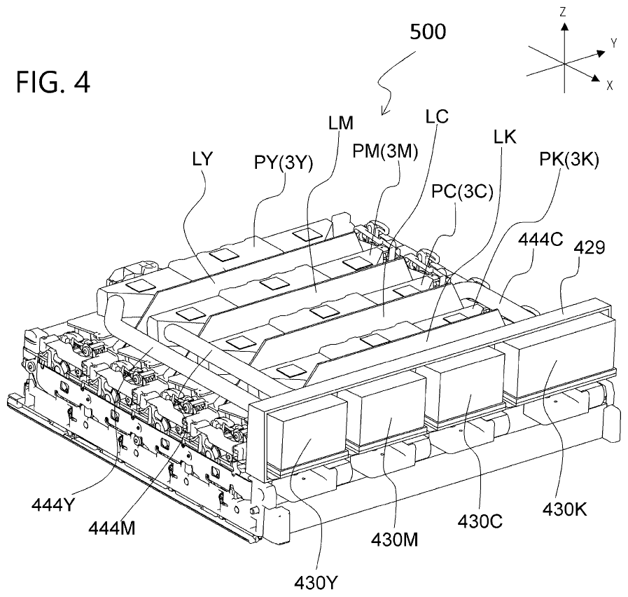

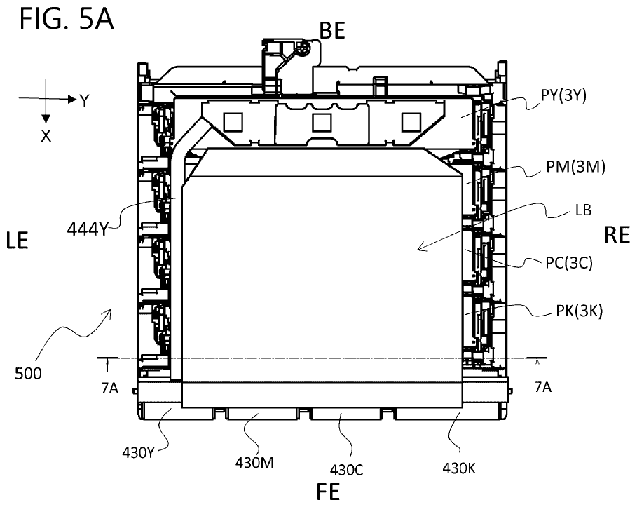

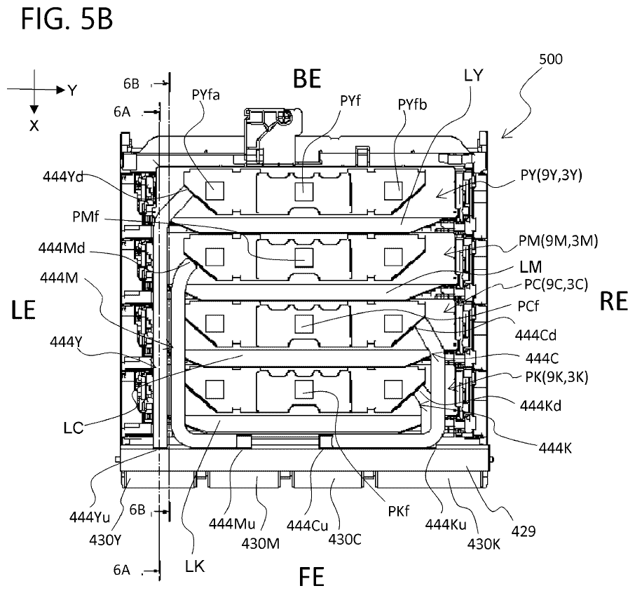

FIG. 4 is a perspective view showing the optical paths LY1, LM1, LC1, and LK1 of the laser beams LY, LM, LC, and LK emitted from the laser scanner LB. In FIGS. 4, 5B, and 7A, the optical paths LY1, LM1, LC1, and LK1 are visualized and illustrated for convenience. FIG. 5A is a plan view showing the laser scanner LB and the image forming unit 500, and FIG. 5B is a plan view showing the image forming unit 500.

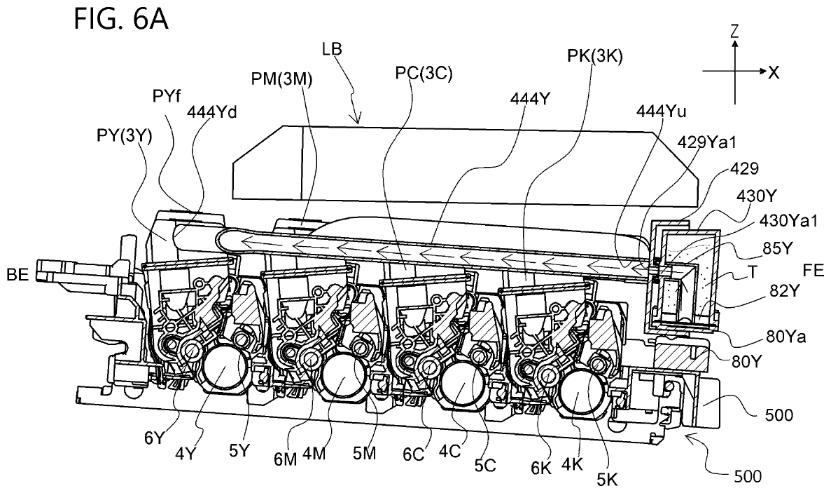

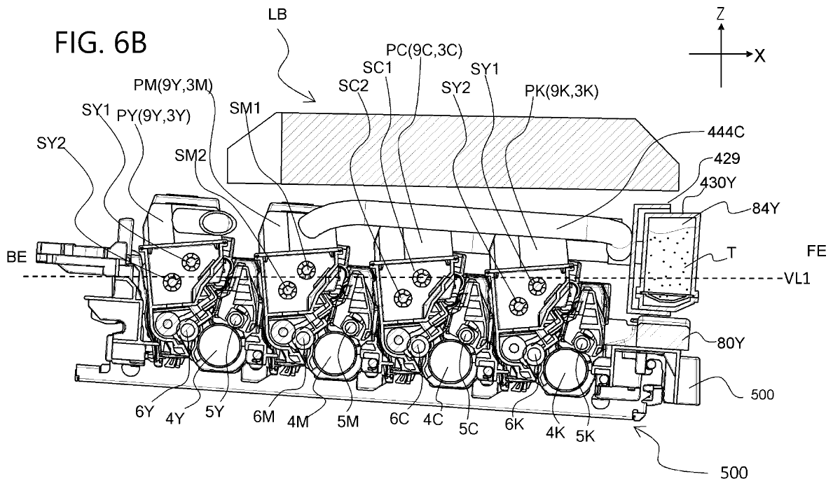

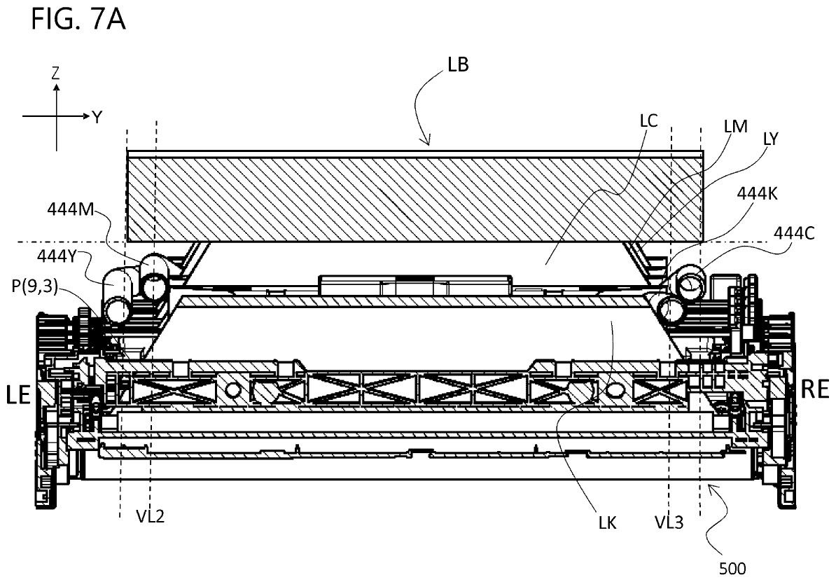

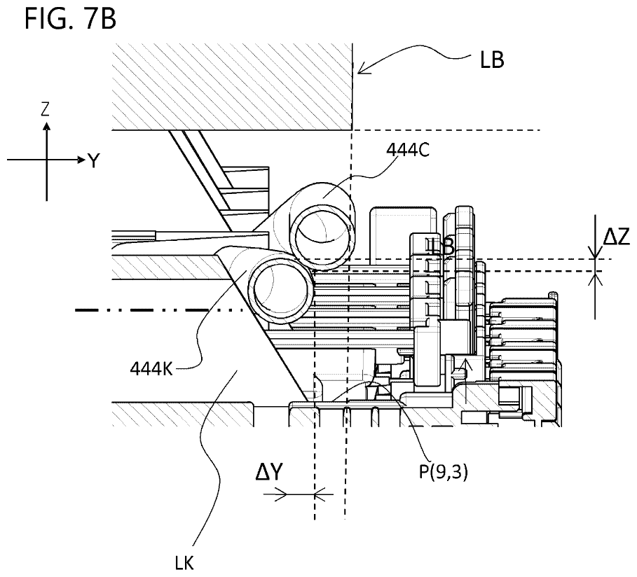

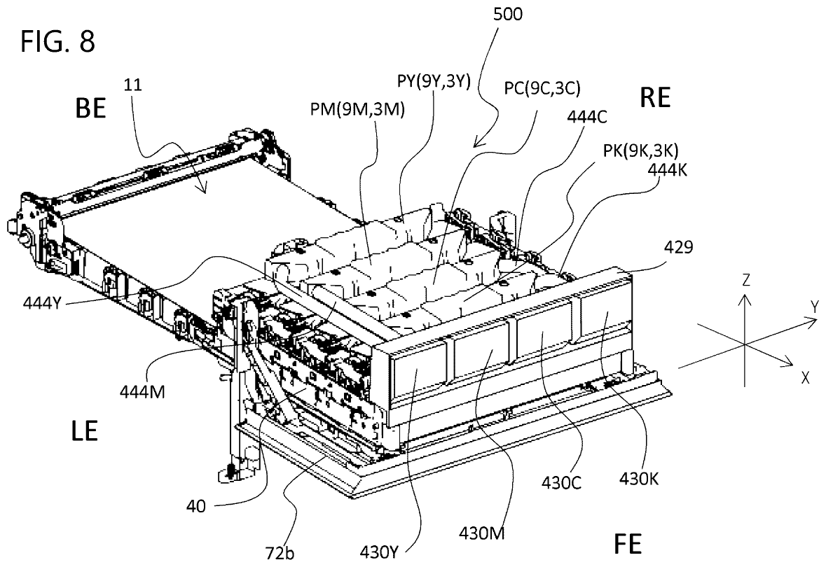

FIG. 6A is a cross-sectional view taken along line 6A-6A of FIG. 5B, and FIG. 6B is a cross-sectional view taken along line 6B-6B of FIG. 5B. FIG. 7A is a cross-sectional view taken along line 7A-7A of FIG. 5A, and FIG. 7B is an enlarged cross-sectional view showing the supply pipes 444C and 444K. FIG. 8 is a perspective view showing a state in which the image forming unit 500 is pulled out from the apparatus body 72.

As shown in FIGS. 3A and 4, the image forming unit 500 includes the process cartridges PY, PM, PC, and PK, the toner cartridges 430Y, 430M, 430C, and 430K, the cartridge holder 429, and pump units 80Y, 80M, 80C, and 80K. The pump units 80Y, 80M, 80C, and 80K are arranged below the cartridge holder 429 and are arranged side by side in the Y direction. The pump units 80Y, 80M, 80C, and 80K are constituted by a positive displacement pump such as a reciprocating pump or a rotary pump, but are not limited thereto. For example, the pump units 80Y, 80M, 80C, and 80K may be constituted by non-positive displacement pumps such as centrifugal pumps, propeller pumps, or viscous pumps.

A reciprocating pump is a pump that performs suction and discharge by the reciprocating motion of a piston or plunger, and includes piston pumps, plunger pumps, and diaphragm pumps. A rotary pump is a pump that performs suction and discharge by rotating gears or rotors, and includes gear pumps, screw pumps, and vane pumps. The four pump units 80Y, 80M, 80C, and 80K may be constituted as a single pump unit, or as two or three pump units. In the present embodiment, the pump units 80Y, 80M, 80C, and 80K are provided in the apparatus body 72, but may also be provided in the toner cartridges 430Y, 430M, 430C, and 430K, respectively.

As shown in FIG. 3B, the pump units 80Y, 80M, 80C, and 80K have discharge ports 80Ya, 80Ma, 80Ca, and 80Ka for discharging air, and these discharge ports 80Ya, 80Ma, 80Ca, and 80Ka are open in the upward direction, i.e., the Z direction.

The cartridge holder 429 is provided with openings respectively facing the discharge ports 80Ya, 80Ma, 80Ca, and 80Ka, and with intake ports 429Ya, 429Ma, 429Ca, and 429Ka. The openings are provided on the lower surface of the cartridge holder 429, and the intake ports 429Ya, 429Ma, 429Ca, and 429Ka are through-holes provided on the rear surface of the cartridge holder 429. The opening direction of the intake ports 429Ya, 429Ma, 429Ca, and 429Ka is the X direction, and thus intersects the Z direction, which is the opening direction of the discharge ports 80Ya, 80Ma, 80Ca, and 80Ka.

In the state where the toner cartridges 430Y, 430M, 430C, and 430K are mounted to the cartridge holder 429, the air discharged from the discharge ports 80Ya, 80Ma, 80Ca, and 80Ka is supplied into the interiors of the toner cartridges 430Y, 430M, 430C, and 430K. The toner discharged from the toner cartridges 430Y, 430M, 430C, and 430K together with the air is received by the supply pipes 444Y, 444M, 444C, and 444K via the intake ports 429Ya, 429Ma, 429Ca, and 429Ka of the cartridge holder 429.

The supply pipes 444Y, 444M, 444C, and 444K include upstream ends 444Yu, 444Mu, 444Cu, and 444Ku connected to the respective intake ports 429Ya, 429Ma, 429Ca, and 429Ka, and downstream ends 444Yd, 444Md, 444Cd, and 444Kd connected to the respective developing containers 3Y, 3M, 3C, and 3K.

The toner discharged from the toner cartridges 430Y, 430M, 430C, and 430K together with the air is supplied to the developing containers 3Y, 3M, 3C, and 3K through the supply pipes 444Y, 444M, 444C, and 444K.

The downstream ends 444Yd and 444Md of the supply pipes 444Y and 444M are connected to the upstream ends in the Y direction, i.e., the left ends, of the developing containers 3Y and 3M, respectively. The downstream ends 444Cd and 444Kd of the supply pipes 444C and 444K are connected to the downstream ends in the Y direction, i.e., the right ends, of the developing containers 3C and 3K, respectively. By thus distributing the supply pipes 444Y, 444M, 444C, and 444K to the left and right sides of the developing containers 3Y, 3M, 3C, and 3K, the lengths of the supply pipes 444Y, 444M, 444C, and 444K can be decreased. Therefore, pressure losses in the supply pipes 444Y, 444M, 444C, and 444K can be reduced, and the image forming unit 500 can be made more compact.

Next, the arrangement of the toner cartridge 430Y will be described. As shown in FIG. 6B, the toner cartridge 430Y and the process cartridges PY, PM, PC, and PK are arranged so as to overlap with a virtual line VL1 extending in the X direction. That is, as shown in FIGS. 1 and 6B, the toner cartridges 430Y, 430M, 430C, and 430K are arranged side by side with the process cartridges PY, PM, PC, and PK in the X direction. In other words, when viewed in the X direction, at least portions of the toner cartridges 430Y, 430M, 430C, and 430K are arranged so as to overlap with the process cartridges PY, PM, PC, and PK in the Z direction. Accordingly, the image forming unit 500 can be made more compact in the Z direction, i.e., the up-down direction, and the image forming apparatus 1 can be made more compact.

In the present embodiment, the toner cartridges 430Y, 430M, 430C, and 430K are arranged as described above, but the arrangement is not limited thereto. That is, the toner cartridges 430Y, 430M, 430C, and 430K may be arranged above the process cartridges PY, PM, PC, and PK in the Z direction.

Next, the arrangement of the supply pipes 444Y, 444M, 444C, and 444K will be described. As shown in FIGS. 4 and 5B, the supply pipes 444Y, 444M, 444C, and 444K are arranged so as not to interfere with the optical paths LY1, LM1, LC1, and LK1 described above.

As described above, the supply pipes 444Y, 444M, 444C, and 444K are distributed and arranged to the left and right sides of the process cartridges PY, PM, PC, and PK. Moreover, the supply pipes 444Y, 444M, 444C, and 444K are arranged below the laser scanner LB.

As shown in FIG. 5A, at least a portion of the supply pipe 444Y does not overlap with the laser scanner LB in plan view. The entire supply pipe 444M overlaps with the laser scanner LB in plan view. The supply pipe 444Y is arranged to the left, i.e., the upstream side in the Y direction, of the supply pipe 444Y. As shown in FIG. 7A, the supply pipes 444Y and 444M are arranged below the laser scanner LB and above the process cartridges PY, PM, PC, and PK. In other words, the supply pipes 444Y and 444M are arranged in the space between the laser scanner LB and the process cartridges PY, PM, PC, and PK in the Z direction.

The optical paths LY1, LM1, LC1, and LK1 widen in the left-right direction, i.e., the Y direction, as they proceed from top to bottom. As shown in FIGS. 5B, 6B, and 7A, the supply pipe 444M is arranged in the space between the laser scanner LB and the optical paths LM1, LC1, and LK1 in the Z direction. That is, as shown in FIG. 7A, when viewed in the X direction, the supply pipe 444M and the optical path LK1 are arranged so as to overlap with a virtual line VL2 extending in the Z direction.

As shown in FIG. 5A, the entire supply pipes 444C and 444K overlap with the laser scanner LB in plan view. The supply pipe 444C is arranged to the right, i.e., the downstream side in the Y direction, of the supply pipe 444K. As shown in FIG. 7A, the supply pipes 444C and 444K are arranged below the laser scanner LB and above the process cartridges PY, PM, PC, and PK. In other words, the supply pipes 444C and 444K are arranged in the space between the laser scanner LB and the process cartridges PY, PM, PC, and PK in the Z direction.

As shown in FIGS. 5B, 6B, and 7A, the supply pipe 444K is arranged in the space between the laser scanner LB and the optical path LK1 in the Z direction. That is, as shown in FIG. 7A, when viewed in the X direction, the supply pipe 444K and the optical path LK1 are arranged so as to overlap with a virtual line VL3 extending in the Z direction.

As shown in FIG. 7B, the supply pipe 444C is arranged above the supply pipe 444K. Moreover, when viewed in the X direction, the supply pipe 444C overlaps with the supply pipe 444K by a distance ΔY in the Y direction. Furthermore, when viewed in the X direction, the supply pipe 444C overlaps with the supply pipe 444K by a distance ΔZ in the Z direction.

As described above, the supply pipes 444Y, 444M, 444C, and 444K are compactly arranged so as not to interfere with the optical paths LY1, LM1, LC1, and LK1, respectively. As a result, the image forming unit 500 and the image forming apparatus 1 can be made more compact. In particular, the image forming unit 500 can be made more compact in both the Y direction and the Z direction. Note that the supply pipes 444Y, 444M, 444C, and 444K do not necessarily need to be arranged as described above.

Also, the image forming unit 500 preferably has a configuration in which the process cartridges PY, PM, PC, and PK and the supply pipes 444Y, 444M, 444C, and 444K can be easily accessed for maintenance or replacement of the process cartridges PY, PM, PC, and PK and the supply pipes 444Y, 444M, 444C, and 444K. Therefore, in the present embodiment, as shown in FIG. 8, the image forming unit 500 is configured to be pulled out in the X direction relative to the apparatus body 72, which includes the intermediate transfer belt unit 11. As a result, the maintainability of the image forming unit 500 can be improved. Note that the image forming unit 500 may also be configured so that it cannot be pulled out in the X direction relative to the apparatus body 72.

### Overall Configuration of Toner Cartridge

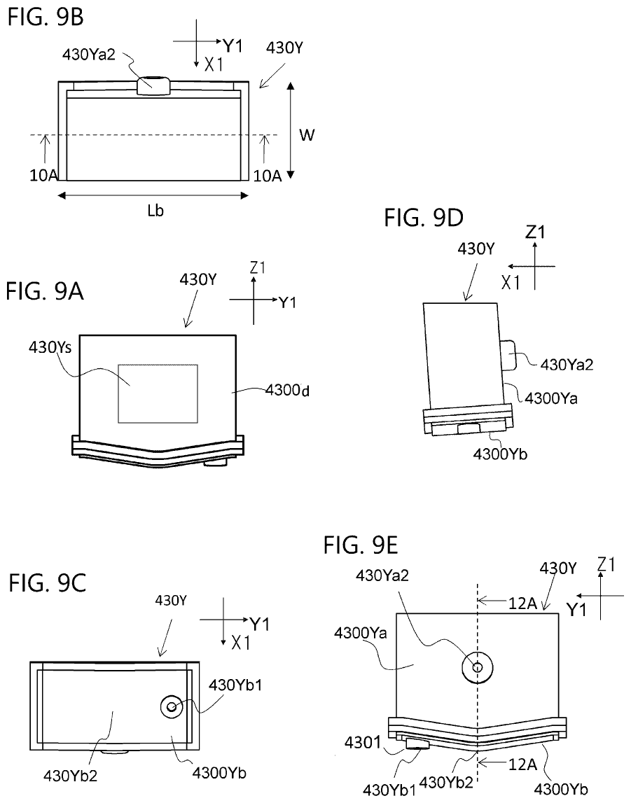

Next, with reference to FIGS. 9A and 9B to 15A and 15B, the overall configuration of the toner cartridge 430Y as a cartridge will be described. FIG. 9A is a front view showing the toner cartridge 430Y, and FIG. 9B is a top view showing the toner cartridge 430Y. FIG. 9C is a bottom view showing the toner cartridge 430Y, FIG. 9D is a side view showing the toner cartridge 430Y, and FIG. 9E is a rear view showing the toner cartridge 430Y.

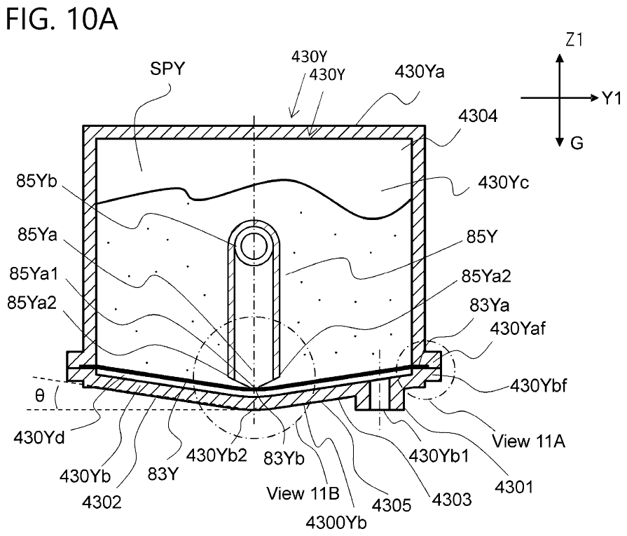

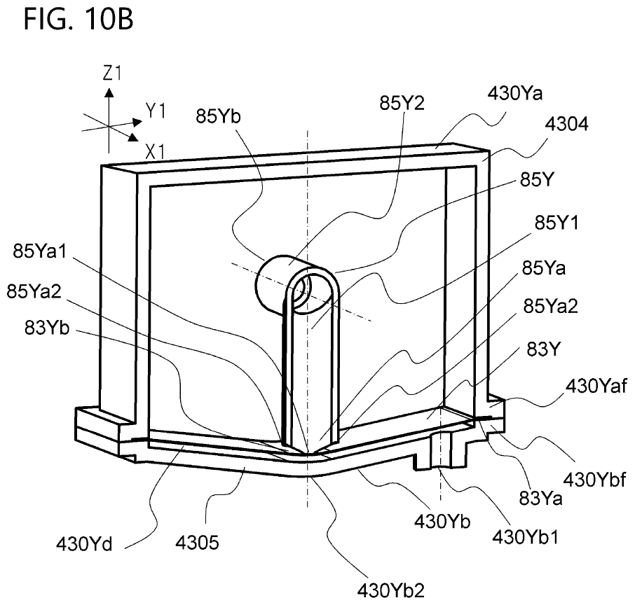

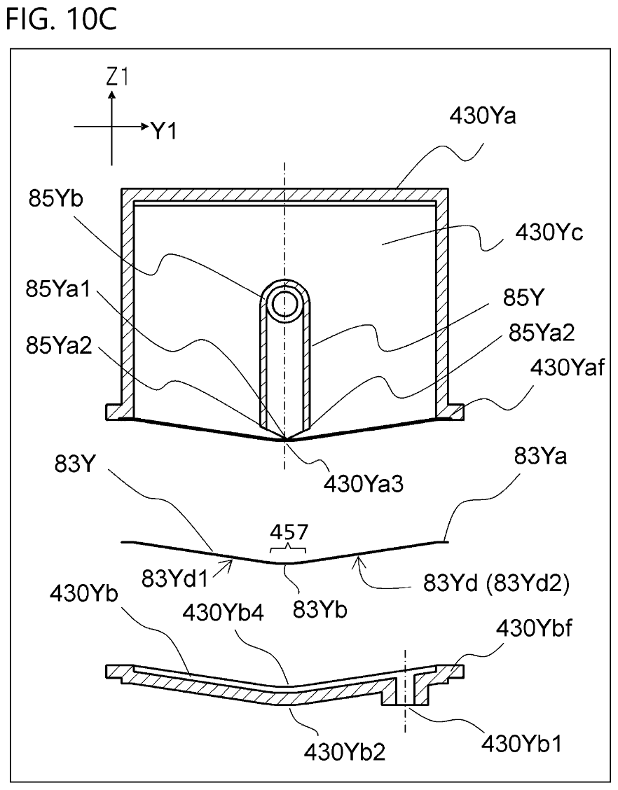

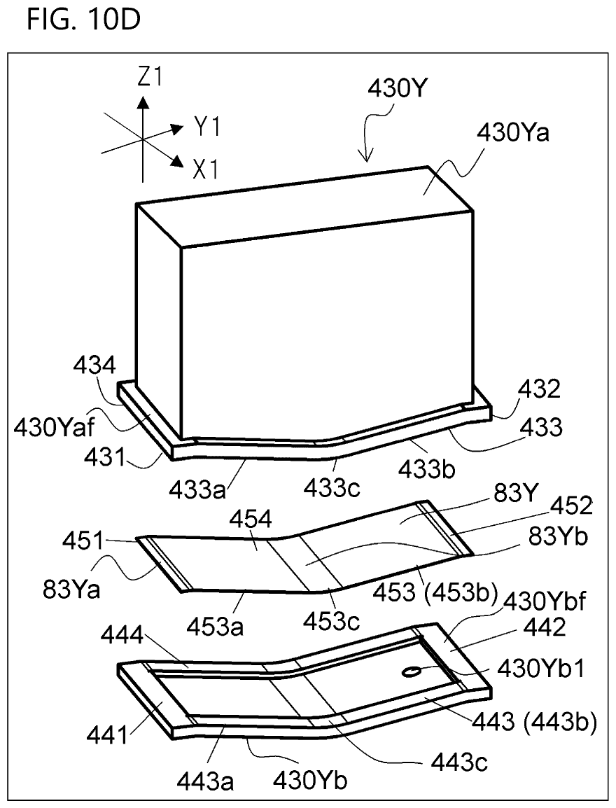

FIGS. 10A, 10B, and 10C are each cross-sectional views taken along line 10A-10A of FIG. 9B, in which FIG. 10A is a front view, FIG. 10B is a perspective view, and FIG. 10C is an exploded front view. FIG. 10D is an exploded perspective view showing the toner cartridge 430Y.

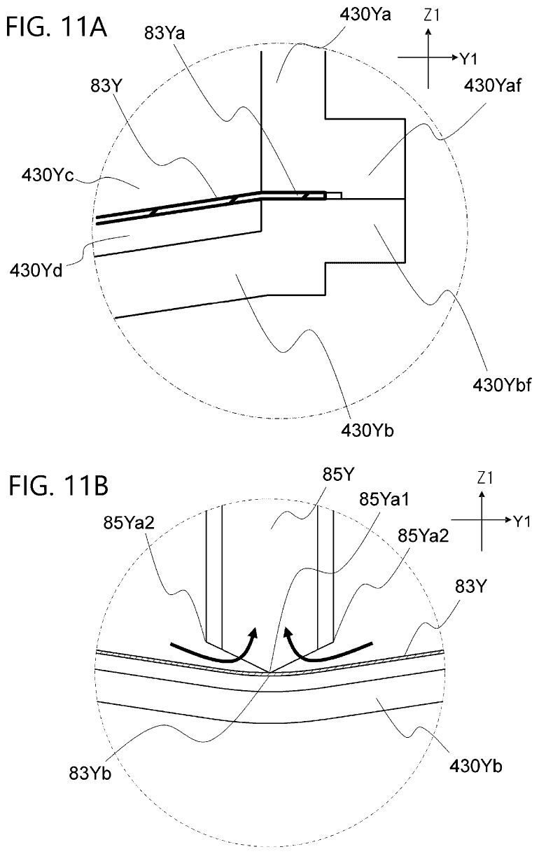

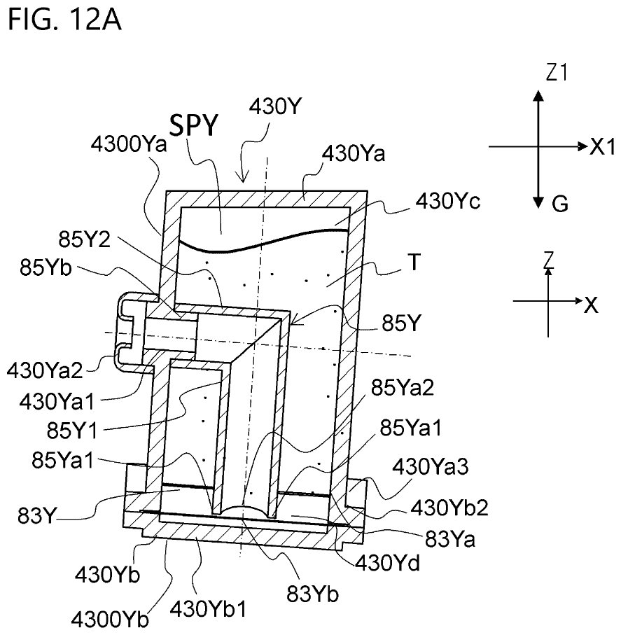

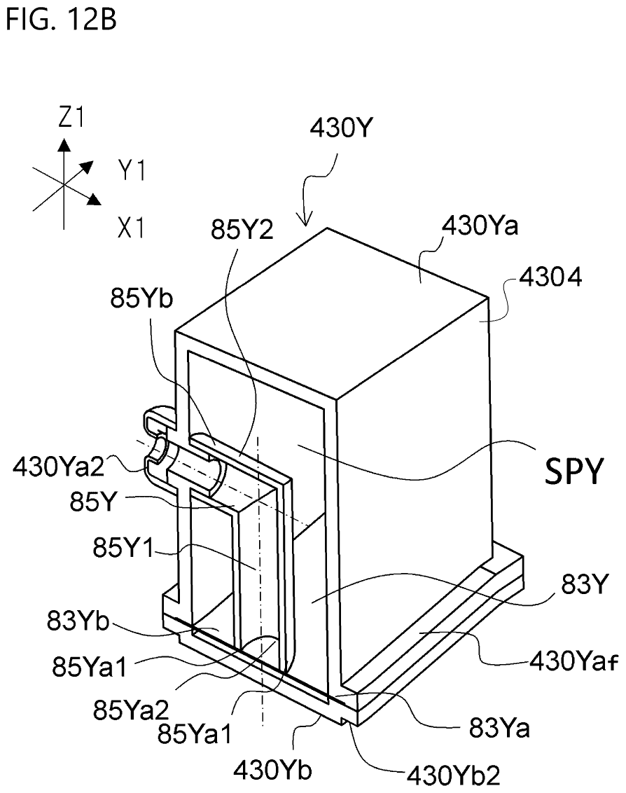

FIG. 11A is an enlarged view showing the joint between the first frame and the second frame shown as View 11A in FIG. 10A, and FIG. 11B is an enlarged view showing the toner inflow portion shown as View 11B in FIG. 10A. FIGS. 12A and 12B are cross-sectional views taken along line 12A-12A of FIG. 9E, in which FIG. 12A is a front view and FIG. 12B is a perspective view.

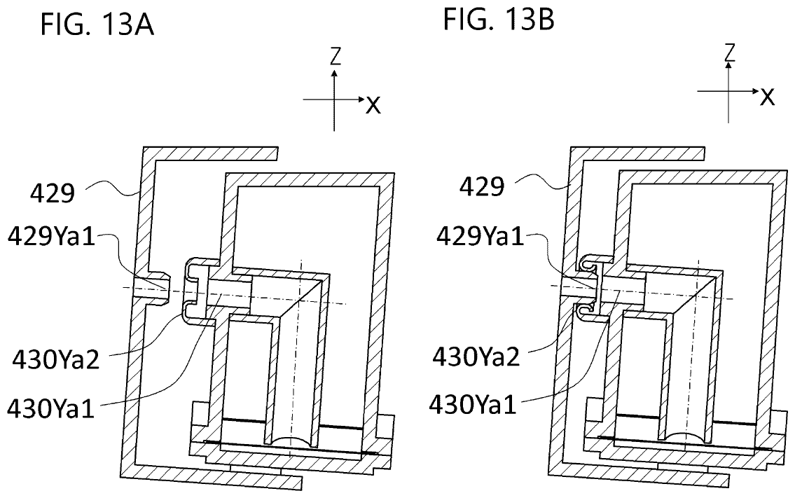

FIGS. 13A, 14A, and 15A are cross-sectional views of toner cartridges having variations of the toner discharge configuration, shown in a state where they are removed from the apparatus body. FIGS. 13B, 14B, and 15B are cross-sectional views showing the toner cartridges mounted to the apparatus body.

As shown in FIG. 3A, the toner cartridge 430K has a width La in the Y direction, and the width La is greater than the respective widths Lb1 of the toner cartridges 430Y, 430M, and 430C. Therefore, the capacity for storing toner in the toner cartridge 430K is larger than that of each of the toner cartridges 430Y, 430M, and 430C. Generally, black toner is consumed more than other color toners, but as described above, the toner cartridge 430K can store more toner than the other toner cartridges 430Y, 430M, and 430C. Accordingly, it is possible to equalize the replacement frequency among the toner cartridges 430Y, 430M, 430C, and 430K and to improve usability.

In the present embodiment, the lengths of the toner cartridges 430Y, 430M, 430C, and 430K in the X direction are equal, and are denoted as length W. The length W in the X direction is shorter than the widths La and Lb1 in the Y direction.

The toner cartridges 430Y, 430M, 430C, and 430K have the same configuration except for the width in the Y direction. Therefore, in the following, only the toner cartridge 430Y will be described, and the description of the toner cartridges 430M, 430C, and 430K will be omitted.

In the following description, unless otherwise specified, it is assumed that the toner cartridge 430Y is in the posture described below, and the directions (X1, Y1, Z1) are defined as shown in FIGS. 9A to 9E to 19A and 19B. That is, the toner cartridge 430Y is in such a posture that the toner storage chamber 430Yc, filter 83Y, and air chamber 430Yd are arranged in this order from top to bottom with respect to the direction of gravity G (opposite to the Z1 direction; see FIG. 10A). When a direction perpendicular to the direction of gravity G is defined as the horizontal direction and a plane in the horizontal direction is defined as a horizontal plane, this posture is defined such that the short side direction (X1 direction) and the long side direction (Y1 direction) of the toner cartridge 430Y are parallel to the horizontal plane. This posture of the toner cartridge 430Y is also referred to as a mounting posture. In this mounting posture, in the direction opposite to the direction of gravity (Z1 direction), the toner storage chamber 430Yc is located above the air chamber 430Yd. In this state, the short side direction of the toner cartridge 430Y is defined as the X1 direction, the long side direction as the Y1 direction, and the direction opposite to the direction of gravity as the Z1 direction. That is, the first direction, which is the direction of gravity G, is the direction in which the second frame 430Yb and the first frame 430Ya are aligned. The second direction, which is the Y1 direction, is the long side direction of the first frame 430Ya, which intersects the Z1 direction in a cross-section perpendicular to the Z1 direction. The third direction, which is the X1 direction, is the short side direction of the first frame 430Ya, which intersects both the Z1 and Y1 directions. Note that, in the mounting posture when the toner cartridge 430Y is attached to the apparatus, the direction of gravity may be referred to as the first direction, the long side direction as the second direction, and the short side direction as the third direction.

The front-rear direction of the toner cartridge 430Y is indicated by the X1 axis, and the direction from the rear to the front of the toner cartridge 430Y is defined as the X1 direction. The X1 direction may also be referred to as the forward direction or the frontward direction. Further, the downstream side in the X1 direction of the toner cartridge 430Y may be referred to as the front side, and the upstream side may be referred to as the rear side.

The left-right direction of the toner cartridge 430Y is indicated by the Y1 axis, and the direction from the left to the right of the toner cartridge 430Y is defined as the Y1 direction. The Y1 direction may also be referred to as the rightward direction. Further, the downstream side in the Y1 direction of the toner cartridge 430Y may be referred to as the right side, and the upstream side may be referred to as the left side.

The up-down direction of the toner cartridge 430Y is indicated by the Z1 axis, and the direction from the bottom to the top of the toner cartridge 430Y is defined as the Z1 direction. The Z1 direction may also be referred to as the upward direction, the height direction, or the vertical direction. Further, the downstream side in the Z1 direction of the toner cartridge 430Y may be referred to as the upper side, the top side, or the ceiling side, and the upstream side may be referred to as the lower side, the bottom side, or the floor side.

The X1 axis, Y1 axis, and Z1 axis are perpendicular to each other. For example, the X1 axis is perpendicular to the Y1 axis and also perpendicular to the Z1 axis. A plane perpendicular to the X1 axis may be referred to as the Y1Z1 plane, a plane perpendicular to the Y1 axis as the Z1X1 plane, and a plane perpendicular to the Z1 axis as the X1Y1 plane.

As shown in FIGS. 9A and 9B to 10A to 10D, the toner cartridge 430Y includes a first frame 430Ya as a first container, a second frame 430Yb as a second container, a filter 83Y, and a discharge pipe 85Y as a pipe portion. In the present embodiment, the first frame 430Ya and the second frame 430Yb are made of a resin material, but may be made of paper or the like. Although details will be described later, the filter 83Y is fixed in a state of being sandwiched between the first frame 430Ya and the second frame 430Yb.

The internal space SPY of the toner cartridge 430Y is partitioned by the filter 83Y into a toner storage chamber 430Yc and an air chamber 430Yd. That is, the toner storage chamber 430Yc is defined by the first frame 430Ya and the filter 83Y. The air chamber 430Yd is defined by the second frame 430Yb and the filter 83Y. The air chamber 430Yd as a second chamber is arranged below the filter 83Y, and the toner storage chamber 430Yc as a first chamber is arranged above the filter 83Y.

The toner storage chamber 430Yc is configured to store toner T (see FIG. 12A). The toner T is supported by the filter 83Y in the direction of gravity within the toner storage chamber 430Yc. No toner T is stored in the air chamber 430Yd. The filter 83Y is made of, for example, a porous member composed of resin fibers. The pores of the filter 83Y are of a size and density that allow the passage of air but restrict the passage of toner T. In other words, the filter 83Y is configured to allow the passage of air and to prevent the passage of toner T.

As shown in FIGS. 9E and 12A, a discharge port seal 430Ya2 is provided on a rear surface 4300Ya of the first frame 430Ya. The discharge port seal 430Ya2 seals a discharge port 430Ya1 through which toner in the toner storage chamber 430Yc is discharged to the outside of the toner cartridge 430Y. The discharge port 430Ya1 as a chamber opening is constituted by a through-hole penetrating the first frame 430Ya in the X1 direction.

As shown in FIGS. 9A, 9C, and 9E, a protrusion 4301 is provided on a bottom surface 4300Yb of the second frame 430Yb so as to protrude downward. An intake port 430Yb1, as container opening (air chamber opening), which is constituted by a through-hole penetrating the second frame 430Yb in the Z direction, is provided in the protrusion 4301. The discharge port 430Ya1 and the intake port 430Yb1 are in communication with the outside of the toner cartridge 430Y.

It is preferable that the discharge port 430Ya1 and the intake port 430Yb1 are provided on sides other than both left and right side surfaces of the toner cartridge 430Y. In other words, it is preferable that the discharge port 430Ya1 and the intake port 430Yb1 are provided on side surfaces of the toner cartridge 430Y other than the side surfaces facing the Y1 direction, which is the direction in which the toner cartridges 430Y, 430M, 430C, and 430K are aligned. Accordingly, it is possible to decrease the gaps Gym, Gmc, and Gck in the Y direction (Y1 direction) between the respective toner cartridges 430Y, 430M, 430C, and 430K, as shown in FIG. 3A. As a result, the width in the Y direction of the toner cartridges 430Y, 430M, 430C, and 430K can be increased, and the capacity for storing toner in the toner cartridges 430Y, 430M, 430C, and 430K can be increased.

The gap Gym is the gap in the Y direction between the toner cartridge 430Y and the toner cartridge 430M. The gap Gmc is the gap in the Y direction between the toner cartridge 430M and the toner cartridge 430C. The gap Gck is the gap in the Y direction between the toner cartridge 430C and the toner cartridge 430K.

Further, as shown in FIG. 10A, the bottom surface 4300Yb of the second frame 430Yb is inclined downward (upstream in the Z direction) toward the center in the Y1 direction. That is, the bottom surface 4300Yb has a first inclined surface 4302 that slopes downward as it proceeds downstream in the Y1 direction, and a second inclined surface 4303 that slopes downward as it proceeds upstream in the Y1 direction. The boundary portion between the first inclined surface 4302 and the second inclined surface 4303 is the lowest surface portion 430Yb2 of the bottom surface 4300Yb.

The above-described protrusion 4301 is provided so as to protrude downward from the second inclined surface 4303 and is arranged at a position offset from the lowest surface portion 430Yb2 in the Y1 direction. As shown in FIG. 3B, the cartridge holder 429 is provided with a positioning portion 429a that engages with the protrusion 4301. In FIG. 3B, only the positioning portion 429a corresponding to the toner cartridge 430Y is indicated by a reference numeral, but the same applies to the other toner cartridges 430M, 430C, and 430K. In the present embodiment, the positioning portion 429a is constituted by a rib provided on the edge of the opening of the cartridge holder 429 that faces the discharge port 80Ya of the pump unit 80Y. The toner cartridge 430Y is positioned relative to the cartridge holder 429 by the engagement of the protrusion 4301 with the positioning portion 429a. At this time, the intake port 430Yb1 provided in the protrusion 4301 of the toner cartridge 430Y is engaged so as to communicate with the discharge port 80Ya of the pump unit 80Y.

As described above, the protrusion 4301 provided with the intake port 430Yb1 is arranged at a position in the Y1 direction that is different from the lowest portion 83Yb of the filter 83Y and the lowest surface portion 430Yb2 of the second frame 430Yb. That is, the protrusion 4301 is arranged in the space between the second inclined surface 4303 and the cartridge holder 429. Accordingly, the space between the second inclined surface 4303 and the cartridge holder 429 can be used efficiently, and the capacity of the toner cartridge 430Y can be increased.

Moreover, the discharge port 430Ya1 and the discharge port seal 430Ya2 provided on the first frame 430Ya of the toner cartridge 430Y open toward the upstream side in the X1 direction. That is, the discharge port 430Ya1 and the discharge port seal 430Ya2 open in the same direction as the mounting direction of the toner cartridge 430Y relative to the cartridge holder 429. Therefore, when the toner cartridge 430Y is mounted to the cartridge holder 429 toward the upstream side in the X1 direction, the discharge port seal 430Ya2 can be easily engaged so as to communicate with the intake port 429Ya1 of the cartridge holder 429.

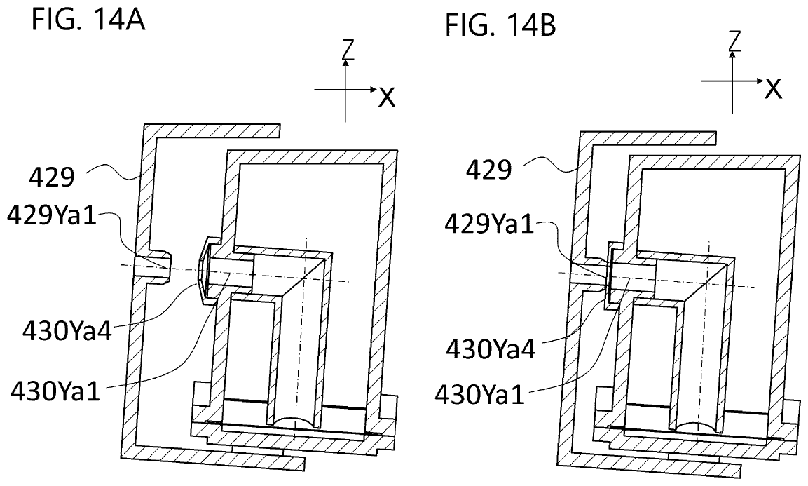

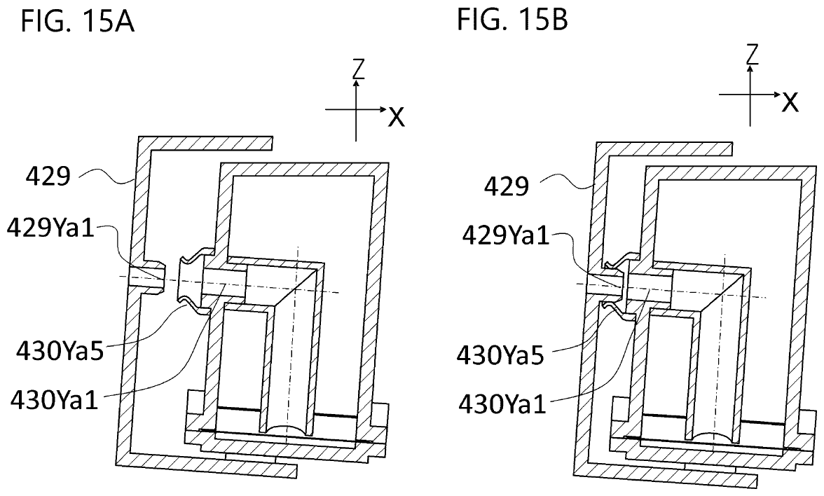

FIG. 13A is a cross-sectional view of a toner cartridge having a variation of the toner discharge configuration, shown in a state where it is removed from the apparatus body, and FIG. 13B is a cross-sectional view showing the toner cartridge mounted to the apparatus body. FIG. 14A is a cross-sectional view of a toner cartridge having a variation of the toner discharge configuration, shown in a state where it is removed from the apparatus body, and FIG. 14B is a cross-sectional view showing the toner cartridge mounted to the apparatus body. FIG. 15A is a cross-sectional view of a toner cartridge having a variation of the toner discharge configuration, shown in a state where it is removed from the apparatus body, and FIG. 15B is a cross-sectional view showing the toner cartridge mounted to the apparatus body. The toner discharge connection portion between the toner cartridge 430Y and the cartridge holder 429 can be connected without leakage by a configuration having a seal member as shown in FIGS. 13A and 13B to 15A and 15B. As shown in FIG. 13A, a cylindrical discharge port seal 430Ya2 with an opening is attached to the discharge port 430Ya1 of the toner cartridge 430Y. The discharge port seal 430Ya2 is made of a flexible material such as an elastomer. When the toner cartridge 430Y is mounted to the cartridge holder 429 from FIG. 13A to FIG. 13B, the thin film portion of the discharge port seal 430Ya2 deforms in the radial direction of the cylinder, widening the opening and connecting to the intake port 429Ya1 of the cartridge holder 429. The intake port 429Ya1 has a cylindrical shape made of a resin material. As described above, since the discharge port seal 430Ya2 is made of a flexible material such as an elastomer and has a high coefficient of friction, a high sealing effect can be expected even with a small amount of deformation, allowing the user to easily attach and detach the toner cartridge with a light operating force.

A similar material may be used to provide a seal in the configurations shown in FIGS. 14A, 14B, 15A, and 15B. In FIGS. 14A and 14B, the seal is deformed in the same X direction as the mounting direction during mounting to ensure airtightness. In FIGS. 15A and 15B, like FIGS. 13A and 13B, the seal is deformed in the radial direction of the cylinder to ensure airtightness. Although the present embodiment describes a configuration in which the discharge port seal member is provided on the toner cartridge side, a configuration in which the seal member is provided on the cartridge holder side may also be employed. In that case, the toner cartridge side has a cylindrical shape made of a resin material, and the cartridge holder side is provided with a seal member made of a flexible material such as an elastomer.

Furthermore, in order to prevent toner leakage from the discharge port 430Ya1, the toner cartridge 430Y may be provided with a sealing member (not shown) in addition to the discharge port seal 430Ya2. The sealing member is preferably constituted by a shutter or a cover member. When the toner cartridge 430Y is not mounted to the cartridge holder 429, the sealing member seals the discharge port seal 430Ya2, thereby suppressing leakage of toner from the toner storage chamber 430Yc to the outside of the toner cartridge 430Y. If the sealing member is constituted by a shutter or a cover member, when the toner cartridge 430Y is mounted to the cartridge holder 429, the sealing member is moved relative to the rear surface 4300Ya of the toner cartridge 430Y to open the discharge port seal 430Ya2. Although the operating force may increase slightly, if the opening of the discharge port seal 430Ya2 is closed when the toner cartridge 430Y is removed from the cartridge holder 429, leakage of toner from the toner storage chamber 430Yc to the outside of the toner cartridge 430Y can be suppressed by the discharge port seal 430Ya2 alone, without using a sealing member.

Moreover, the arrangement is not limited to the above, and the discharge port 430Ya1 may be provided on the bottom surface 4300Yb or a top surface 4300Yc of the toner cartridge 430Y, and the intake port 430Yb1 may be provided on the rear surface 4300Ya or the top surface 4300Yc of the toner cartridge 430Y. Additionally, if there is sufficient space in the apparatus body 72, the discharge port 430Ya1 and the intake port 430Yb1 may be provided on both left and right side surfaces of the toner cartridge 430Y.

Furthermore, as shown in FIG. 9A, a label 430Ys is provided on the front surface 4300d of the toner cartridge 430Y. The label 430Ys is for indicating the color of the toner stored in the toner cartridge 430Y. Note that the label 430Ys is omitted in drawings other than FIG. 9A. The label 430Ys may also display information on how to mount the toner cartridge 430Y to the cartridge holder 429, or other information regarding the toner cartridge 430Y. For example, the label 430Ys may indicate the toner capacity of the toner cartridge 430Y, the expiration date of the toner, storage instructions for the toner cartridge 430Y, or instructions for removing the above-mentioned sealing member.

### Toner Conveying Mechanism

Next, a mechanism by which the toner stored in the toner storage chamber 430Yc of the toner cartridge 430Y is conveyed to the developing container 3Y of the process cartridge PY will be described. As shown in FIG. 6A, air discharged upward from the discharge port 80Ya of the pump unit 80Y is introduced into the air chamber 430Yd via the intake port 430Yb1 of the toner cartridge 430Y (see FIG. 10A). This air fills the air chamber 430Yd, passes through the filter 83Y, and flows into the toner storage chamber 430Yc.

The air flowing into the toner storage chamber 430Yc enters between the particles of toner T and fluidizes the toner T. Due to the inflow of air from the pump unit 80Y, the inside of the toner cartridge 430Y becomes positively pressurized, and the air attempts to exit the toner cartridge 430Y through the discharge port 430Ya1 via the discharge pipe 85Y. At this time, the toner T in the toner storage chamber 430Yc moves through the discharge pipe 85Y together with the air and is discharged to the outside of the toner cartridge 430Y through the discharge port 430Ya1 via the discharge port seal 430Ya2. In other words, the discharge pipe 85Y guides the toner in the toner storage chamber 430Yc together with air from an inlet 85Ya to the discharge port 430Ya1.

The toner T discharged from the discharge port 430Ya1 via the discharge port seal 430Ya2 enters the upstream end 444Yu of the supply pipe 444Y via the intake port 429Ya of the cartridge holder 429. The toner T is then conveyed through the inside of the supply pipe 444Y by the air that has also entered the supply pipe 444Y, and is supplied to the developing container 3Y of the process cartridge PY from the downstream end 444Yd of the supply pipe 444Y. As shown in FIG. 5B, since the downstream end 444Yd of the supply pipe 444Y is connected to the upstream end in the Y direction (Y1 direction) of the developing container 3Y, the toner T is supplied to the upstream end in the Y direction of the developing container 3Y.

Here, inside the developing container 3Y, as shown in FIG. 6B, stirring members SY1 and SY2 for stirring the toner in the developing container 3Y are rotatably provided. Similarly, inside the developing containers 3M, 3C, and 3K, sets of stirring members SM1 and SM2, SC1 and SC2, and SK1 and SK2 are provided, respectively.

The toner in the developing container 3Y is leveled and conveyed in the Y direction (Y1 direction) by the rotation of the stirring members SY1 and SY2. In the present embodiment, these stirring members are constituted by a rotating shaft and a sheet member fixed to the rotating shaft, but the configuration is not limited thereto. For example, the stirring members may be constituted by screws configured to convey the toner in the developing container along the Y direction. That is, the stirring members SY1, SY2, SM1, and SM2 may be constituted by screws that convey the toner downstream in the Y direction, and the stirring members SC1, SC2, SK1, and SK2 may be constituted by screws that convey the toner upstream in the Y direction.

Since not only toner T but also air flows into the developing container 3Y, the internal pressure of the developing container 3Y rises. Therefore, in the present embodiment, a through-hole (not shown) is provided on the top surface of the developing container 3Y and covered by an exhaust filter PYf (see FIGS. 3A and 5B). The exhaust filter PYf is made of nonwoven fabric or the like and is configured to allow the passage of air while restricting the passage of toner. Thus, the toner that has flowed into the developing container 3Y is prevented from being discharged to the outside by the exhaust filter PYf and remains in the developing container 3Y. On the other hand, at least a portion of the air that has flowed into the developing container 3Y passes through the exhaust filter PYf and is discharged to the outside of the developing container 3Y. As a result, the rise in internal pressure in the developing container 3Y can be suppressed and the developing container 3Y can be replenished with toner smoothly.

Similarly, exhaust filters PMf, PCf, and PKf and through-holes (not shown) covered by these exhaust filters PMf, PCf, and PKf are provided on the top surfaces of the developing containers 3M, 3C, and 3K.

The exhaust filter PYf and the through-hole are provided in the central portion of the developing container 3Y in the Y direction. These exhaust filters and through-holes are not limited to one each, and may be provided in plural in the developing container 3Y. For example, as shown in FIGS. 3A and 5B, in addition to the exhaust filter PYf, exhaust filters PYfa and PYfb may be provided in the developing container 3Y. The exhaust filters PYfa and PYfb cover through-holes (not shown) provided in the developing container 3Y. The exhaust filter PYfa is arranged upstream of the exhaust filter PYf in the Y direction, and the exhaust filter PYfb is arranged downstream of the exhaust filter PYf in the Y direction. By providing a plurality of exhaust filters and through-holes for a single developing container in this manner, the rise in internal pressure in the developing container can be efficiently suppressed.

As described above, the toner stored in the toner cartridge 430Y is conveyed together with air to the developing container 3Y and supplied to the developing container 3Y. In a configuration where the direction of the conveying path changes midway, as in the supply pipes 444Y, 444M, 444C, and 444K of the present embodiment, or where the conveying path differs depending on the color of the toner, it is preferable to convey the toner using air. By conveying the toner using air, the degree of freedom in designing the toner conveying path is increased, and components such as screws for conveying the toner are unnecessary, thereby reducing the number of parts and lowering the cost.

### Detailed Configuration of Toner Cartridge

### Frame

Next, the detailed configuration of the toner cartridge 430Y will be described with reference to FIGS. 10A and 10B to 12A and 12B. As shown in FIGS. 10A and 10B to 12A and 12B, the first frame 430Ya includes a first box portion 4304 that forms the toner storage chamber 430Yc together with the bottom surface portion 83Yd of the filter 83Y, and a first flange portion 430Yaf that extends from the lower end of the first box portion 4304 substantially horizontally outward from the toner storage chamber 430Yc. The first box portion 4304 is formed in a substantially rectangular parallelepiped shape. The first flange portion 430Yaf is formed around the entire circumference of the lower end of the first box portion 4304.

The second frame 430Yb is formed separately from the first frame 430Ya and includes a second box portion 4305 that forms the air chamber 430Yd together with the bottom surface portion 83Yd of the filter 83Y, and a second flange portion 430Ybf that extends from the upper end of the second box portion 4305 substantially horizontally outward from the air chamber 430Yd. The second flange portion 430Ybf is formed around the entire circumference of the upper end of the second box portion 4305.

### Filter

The filter 83Y is formed in a rectangular, sheet-like shape. The filter 83Y includes a bottom surface portion 83Yd serving as a partition that divides the air chamber 430Yd and the toner storage chamber 430Yc, and an outer edge 83Ya serving as a sandwiched portion held between the first flange portion 430Yaf and the second flange portion 430Ybf. The outer edge 83Ya is provided so as to be continuous with the bottom surface portion 83Yd.

The bottom surface portion 83Yd is formed so as to approach the lowest portion 83Yb of the filter 83Y in the long side direction (Y1 direction) as it proceeds downward in the direction of gravity G, and constitutes the bottom surface of the toner storage chamber 430Yc. In other words, when viewed in the X1 direction, the bottom surface portion 83Yd is inclined downward in the direction of gravity G toward the lowest portion 83Yb as it approaches the lowest portion 83Yb of the filter 83Y in the Y1 direction. As shown in FIG. 10C, the bottom surface portion 83Yd has a first inclined surface 83Yd1 that slopes downward as it approaches the lowest portion 83Yb from one end (upstream end) of the bottom surface portion 83Yd in the Y1 direction, and a second inclined surface 83Yd2 that slopes downward as it approaches the lowest portion 83Yb from the other end (downstream end) of the bottom surface portion 83Yd in the Y1 direction.

In other words, when viewed in the X1 direction, assuming that the two ends of the toner cartridge 430Y in the Y1 direction are defined as a first end and a second end, the lowest portion 83Yb of the filter 83Y is arranged between the first end and the second end in the Y1 direction. The first part, which is the first inclined surface 83Yd1, is configured to slope downward as it approaches the lowest portion 83Yb from the first end in the Y1 direction, and the second part, which is the second inclined surface 83Yd2, is configured to slope downward as it approaches the lowest portion 83Yb from the second end in the Y1 direction.

The bottom surface portion 83Yd may also have an intermediate portion 457 at a location corresponding to the lowest portion 83Yb located between the first inclined surface 83Yd1 and the second inclined surface 83Yd2 in the Y1 direction. The intermediate portion 457 is curved so as to smoothly connect the first inclined surface 83Yd1 and the second inclined surface 83Yd2. Alternatively, the intermediate portion 457 may be omitted, and the first inclined surface 83Yd1 and the second inclined surface 83Yd2 may be directly connected.

### Joining Surface

As shown in FIG. 10D, the first flange portion 430Yaf of the first frame 430Ya has a first joining surface 431, a second joining surface 432, a third joining surface 433, and a fourth joining surface 434. The second flange portion 430Ybf of the second frame 430Yb has a first joining surface 441, a second joining surface 442, a third joining surface 443, and a fourth joining surface 445. The outer edge 83Ya of the filter 83Y has a first edge 451, a second edge 452, a third edge 453, and a fourth edge 454. The first joining surface 431 and the second joining surface 432 of the first flange portion 430Yaf are each formed in a planar shape extending in the X1 direction. The first joining surface 431 and the second joining surface 432 are formed continuously with the third joining surface 433 and the fourth joining surface 434, respectively. The first joining surface 431 is provided at the left end side of the first flange portion 430Yaf, and the second joining surface 432 is provided at the right end side of the first flange portion 430Yaf. The third joining surface 433 is provided at the front end side of the first flange portion 430Yaf, and the fourth joining surface 434 is provided at the rear end side of the first flange portion 430Yaf. Since the third joining surface 433 and the fourth joining surface 434 are similarly configured, the third joining surface 433 will be mainly described.

The third joining surface 433 has a first inclined surface 433a as an inclined surface that slopes downward as it proceeds downstream in the Y1 direction, a second inclined surface 433b that slopes downward as it proceeds upstream in the Y1 direction, and an intermediate surface 433c. The first inclined surface 433a slopes downward in the direction of gravity G toward the lowest portion 83Yb as it approaches the lowest portion 83Yb in the Y1 direction. The second inclined surface 433b is arranged opposite to the first inclined surface 433a with respect to the lowest portion 83Yb in the Y1 direction, and slopes downward in the direction of gravity G toward the lowest portion 83Yb as it approaches the lowest portion 83Yb. The intermediate surface 433c is provided between the first inclined surface 433a and the second inclined surface 433b in the X1 direction, and is curved so as to smoothly connect the first inclined surface 433a and the second inclined surface 433b.

Alternatively, the intermediate surface 433c may be omitted, and the first inclined surface 433a and the second inclined surface 433b may be directly connected. Alternatively, the intermediate surface 433c may be formed as a flat surface. Furthermore, not limited to the entirety of the first inclined surface 433a, a portion of the first inclined surface 433a may constitute an inclined surface or a clamping surface.

The first joining surface 441 and the second joining surface 442 of the second flange portion 430Ybf are each formed as a flat surface extending in the X1 direction. The first joining surface 441 is provided at the left end side of the second flange portion 430Ybf, and the second joining surface 442 is provided at the right end side of the second flange portion 430Ybf. The third joining surface 443 is provided at the front end side of the second flange portion 430Ybf, and the fourth joining surface 445 is provided at the rear end side of the second flange portion 430Ybf. Since the third joining surface 443 and the fourth joining surface 445 are similarly configured, the third joining surface 443 will be mainly described.

The third joining surface 443 includes a first inclined surface 443a, which serves as a clamping surface and a first clamping surface, and slopes downward as it proceeds downstream in the Y1 direction, a second inclined surface 443b, which serves as a second clamping surface and slopes downward as it proceeds upstream in the Y1 direction, and an intermediate surface 443c, which serves as an intermediate clamping surface. The first inclined surface 443a, the second inclined surface 443b, and the intermediate surface 443c are respectively opposed to the first inclined surface 433a, the second inclined surface 433b, and the intermediate surface 433c in the direction of gravity G. In other words, the first inclined surface 443a, the second inclined surface 443b, and the intermediate surface 443c are respectively arranged at positions overlapping the first inclined surface 433a, the second inclined surface 433b, and the intermediate surface 433c in the direction of gravity G.

The intermediate surface 443c is provided between the first inclined surface 443a and the second inclined surface 443b in the Y1 direction, and is curved so as to smoothly connect the first inclined surface 443a and the second inclined surface 443b. The first inclined surface 443a and the second inclined surface 443b each slope downward as they approach the lowest portion 83Yb of the filter 83Y in the Y1 direction. Alternatively, the intermediate surface 443c may be omitted and the first inclined surface 443a and the second inclined surface 443b may be directly connected, or the intermediate surface 443c may be formed as a flat surface. Furthermore, not limited to the entirety of the first inclined surface 443a, a portion of the first inclined surface 443a may constitute a clamping surface or an inclined surface.

The first edge 451 and the second edge 452 of the outer edge 83Ya of the filter 83Y are each formed as a flat surface extending in the X1 direction. The first edge 451 is provided at the left end side of the outer edge 83Ya, and the second edge 452 is provided at the right end side of the outer edge 83Ya. The third edge 453 is provided at the front end side of the outer edge 83Ya, and the fourth edge 454 is provided at the rear end side of the outer edge 83Ya. Since the third edge 453 and the fourth edge 454 are similarly configured, the third edge 453 will be mainly described.

The third edge 453 includes a first inclined surface 453a, which serves as a clamped surface and a first clamped surface, and slopes downward as it proceeds downstream in the Y1 direction, a second inclined surface 453b, which serves as a second clamped surface and slopes downward as it proceeds upstream in the Y1 direction, and an intermediate surface 453c, which serves as an intermediate clamped surface. The first inclined surface 453a of the filter 83Y is opposed, in the direction of gravity G, to the first inclined surface 433a of the first flange portion 430Yaf and the first inclined surface 443a of the second flange portion 430Ybf. The second inclined surface 453b of the filter 83Y is opposed, in the direction of gravity G, to the second inclined surface 433b of the first flange portion 430Yaf and the second inclined surface 443b of the second flange portion 430Ybf. The intermediate surface 453c of the filter 83Y is opposed, in the direction of gravity G, to the intermediate surface 433c of the first flange portion 430Yaf and the intermediate surface 443c of the second flange portion 430Ybf.

Then, the first joining surface 431 of the first flange portion 430Yaf and the first joining surface 441 of the second flange portion 430Ybf are ultrasonically welded together. Similarly, the second joining surface 432 of the first flange portion 430Yaf and the second joining surface 442 of the second flange portion 430Ybf are ultrasonically welded together. Similarly, the third joining surface 433 of the first flange portion 430Yaf and the third joining surface 443 of the second flange portion 430Ybf are ultrasonically welded together. Similarly, the fourth joining surface 434 of the first flange portion 430Yaf and the fourth joining surface 444 of the second flange portion 430Ybf are ultrasonically welded together. As a result, the first flange portion 430Yaf and the second flange portion 430Ybf are joined. At this time, the third joining surface 433 of the first flange portion 430Yaf, the third joining surface 443 of the second flange portion 430Ybf, the fourth joining surface 434 of the first flange portion 430Yaf, and the fourth joining surface 444 of the second flange portion 430Ybf are arranged so as to overlap the bottom surface portion 83Yd of the filter 83Y when viewed in the short side direction (X1 direction). Note that the first flange portion 430Yaf and the second flange portion 430Ybf may be fixed together not only by ultrasonic welding but also by heat welding, adhesives such as double-sided tape or hot melt, or screws or the like.

By joining the first flange portion 430Yaf and the second flange portion 430Ybf, the filter 83Y sandwiched between the first flange portion 430Yaf and the second flange portion 430Ybf is held in place. If the holding force for the filter 83Y is insufficient, the entire circumference of the outer edge 83Ya of the filter 83Y may be adhered to at least one of the first flange portion 430Yaf and the second flange portion 430Ybf. As a result, the filter 83Y can be held with a high holding force.

Furthermore, since the filter 83Y is clamped between the first flange portion 430Yaf and the second flange portion 430Ybf, the filter 83Y is held in a posture along the respective joining surfaces of the first flange portion 430Yaf and the second flange portion 430Ybf. In particular, since the third edge 453 of the filter 83Y is clamped by the third joining surfaces 433 and 443, which are formed in a substantially V-shape, and the fourth edge 454 of the filter 83Y is clamped by the fourth joining surfaces 434 and 444, which are also formed in a substantially V-shape, the filter 83Y is held in a substantially V-shaped posture with the lowest portion 83Yb as the lowermost point when viewed from the X direction.

The lowest portion 83Yb of the filter 83Y extends in the short side direction (X1 direction), and the bottom surface portion 83Yd of the filter 83Y extends parallel to the short side direction (X1 direction) over the entire area in the short side direction (X1 direction). In other words, in a predetermined cross-section perpendicular to the long side direction (Y1 direction), the bottom surface portion 83Yd is at an equal distance from the outlet 85Yb in the direction of gravity G or the Z1 direction over the entire area in the short side direction (X1 direction). That is, as shown in FIG. 12A, in the X1Z1 plane, the distance GD in the Z1 direction between the center 430Ya5 of the discharge port 430Ya1 and the bottom surface portion 83Yd is equal over the entire area in the short side direction (X1 direction). Additionally, the first joining surface 441 is opposed to the first joining surface 431 in the direction of gravity G. In other words, the first joining surface 441 is arranged at a position overlapping the first joining surface 431 in the direction of gravity G.

That is, the filter 83Y is formed by folding a single rectangular sheet at the lowest portion 83Yb, and does not have a complex three-dimensional shape with concavities and convexities. Therefore, the filter 83Y can be formed from a sheet-like nonwoven fabric made of resin fibers, for example, and does not need to be three-dimensionally shaped by heat pressing or the like. In other words, when the outer edge 83Ya of the filter 83Y is not clamped between the first frame 430Ya and the second frame 430Yb, the filter 83Y is a flat sheet. Thus, it is possible to configure the filter 83Y at low cost while holding the filter 83Y in a substantially V-shaped posture. Compared to a molded component formed by heat pressing or the like, the sheet-like filter 83Y can be made thinner, which increases the toner capacity of the toner cartridge 430Y.

Normally, to allow toner to move along a slope by its own weight alone, the angle of inclination θ of the slope relative to the horizontal plane needs to be set to about 70 degrees. However, in the present embodiment, the toner on the filter 83Y in the toner storage chamber 430Yc is fluidized by air. Therefore, as shown in FIG. 10A, the angle of inclination of the slope of the filter 83Y relative to the horizontal plane only needs to be about 10 to 20 degrees. As a result, the capacity of the toner cartridge 430Y can be increased and the amount of toner to be stored in the toner cartridge 430Y can be increased.

In the present embodiment, both the first frame 430Ya and the second frame 430Yb are provided with the third joining surfaces 433 and 443, which contact the third edge 453 of the outer edge 83Ya of the filter 83Y and are inclined relative to the long side direction (Y1 direction) and the direction of gravity G, but the configuration is not limited thereto. That is, at least one of the first frame 430Ya and the second frame 430Yb may be provided with the third joining surface 433, and at least the other of the first frame 430Ya and the second frame 430Yb may be provided with a clamping surface for clamping the third edge 453 together with the third joining surface 433. For example, only the first frame 430Ya, among the first frame 430Ya and the second frame 430Yb, may be provided with the third joining surface 433, which contacts the third edge 453 and is inclined relative to the long side direction (Y1 direction) and the direction of gravity G. In this case, the third joining surface 443 of the second frame 430Yb as the clamping surface may be formed parallel to the Y1Z1 plane, and a seal member (not shown) may be provided between the third joining surface 433 and the third joining surface 443.

### Relationship Between Discharge Pipe and Filter

Next, the relationship between the discharge pipe and the filter, which is a characteristic configuration of the present embodiment, will be described. As shown in FIGS. 10A to 10C, the discharge pipe 85Y is arranged inside the toner storage chamber 430Yc. The discharge pipe 85Y has the inlet 85Ya (first opening) that opens downward in the direction of gravity G, and the outlet 85Yb, as a second pipe opening (second opening), that opens toward the rear, i.e., upstream in the X1 direction, communicates with the discharge port 430Ya1 of the toner cartridge 430Y, and connects to the outside of the toner cartridge 430Y. The outlet 85Yb is positioned above the inlet 85Ya.

As shown in FIGS. 12A and 12B, the discharge pipe 85Y has a first pipe portion 85Y1 extending in the Z1 direction or the direction of gravity G and provided with the inlet 85Ya, and a second pipe portion 85Y2 extending in the X1 direction and provided with the outlet 85Yb connected to the discharge port 430Ya1, and the discharge pipe 85Y is bent midway. Thus, as a pipe, the discharge pipe 85Y connects the inlet 85Ya and the outlet 85Yb. The inlet 85Ya is arranged near the central portion of the container in the X1 direction. In the X1 direction, no slope is provided to the filter 83Y, and thus the effect of conveying the toner is weak. By arranging the discharge pipe 85Y near the central portion, the distances from both ends in the X1 direction to the inlet 85Ya become equal. Therefore, compared to a configuration in which the inlet 85Ya is arranged at one end and the distance to the other end is large, the amount of toner that remains in the toner storage chamber 430Yc without being supplied can be reduced. In the present embodiment, the discharge pipe 85Y is made of a resin material, but it may also be made of paper, rubber, or the like.

As shown in FIG. 11B, the inlet 85Ya has a V-shaped configuration that is sharper than the filter 83Y, resembling a shape formed by cutting off both sides of a circular pipe. The inlet 85Ya includes two contact portions 85Ya1 that contact the lowest portion 83Yb of the filter 83Y as the opposing region, and two gap portions 85Ya2 that are arranged to face the lowest portion 83Yb with a gap in the direction of gravity G. The space formed by the filter 83Y and the gap portions 85Ya2 serves as the toner inflow port (indicated by the arrow in FIG. 11B). Therefore, it can be said that the lower end surface of the pipe has a first region (contact portion) that contacts the filter 83Y positioned below the pipe, and a second region (gap portion) that does not contact the filter 83Y.

As described above, the filter 83Y is held in a substantially V-shaped posture with the lowest portion 83Yb as the lowermost point. When the remaining amount of toner in the toner storage chamber 430Yc decreases, the toner fluidized by air moves along the slope of the filter 83Y and gathers at the lowest portion 83Yb. That is, the toner in the toner storage chamber 430Yc can be guided toward the inlet 85Ya of the discharge pipe 85Y. Moreover, the bottom surface portion 83Yd of the filter 83Y is not inclined in the short side direction (X1 direction), but only in the long side direction (Y1 direction). Therefore, while keeping the filter 83Y simple, the toner can be efficiently collected at the lowest portion 83Yb of the filter 83Y. Thus, even when the remaining amount of toner in the toner storage chamber 430Yc is small, the toner collected at the lowest portion 83Yb can be efficiently discharged through the discharge pipe 85Y. During this discharge, the toner moves from the inlet 85Ya to the outside of the toner cartridge 430Y via the discharge port 430Ya1.

Furthermore, by bringing the inlet 85Ya of the discharge pipe 85Y into contact with the lowest portion 83Yb of the filter 83Y, the relative positional relationship is ensured. If the inlet 85Ya of the discharge pipe 85Y and the lowest portion 83Yb of the filter 83Y are not in contact and a certain amount of gap is provided, the gap may easily vary due to component tolerances, sagging or deflection of the filter, vibration, and the like. If the gap is too small, toner may not pass easily, causing clogging, whereas if the gap is too large, the amount of toner remaining in the container may increase and not be fully discharged. Compared to this, the configuration of the present embodiment makes gap management easier.

Although the present embodiment manages the gap by bringing the discharge pipe into contact with the filter, the gap may also be managed by attaching another member to the discharge pipe to bring it into contact with the filter.

The discharge port 430Ya1 is arranged above the inlet 85Ya and the bottom surface portion 83Yd of the filter 83Y, but the toner is conveyed from the inlet 85Ya to the discharge port 430Ya1 by air.

With the above-described configuration, the amount of toner that remains in the toner storage chamber 430Yc without being supplied can be reduced.

### Other Embodiments

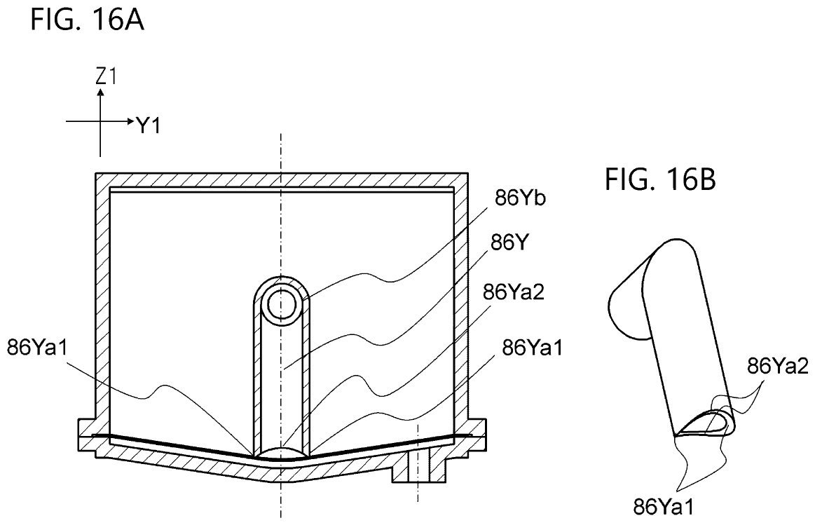

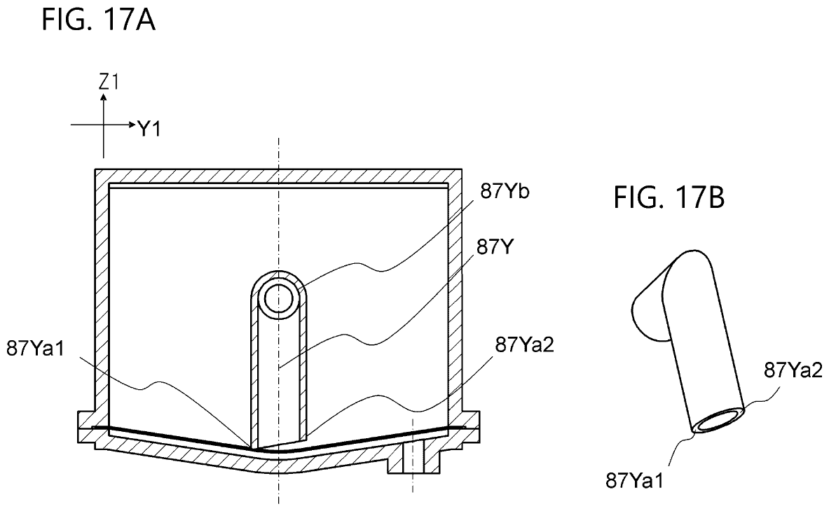

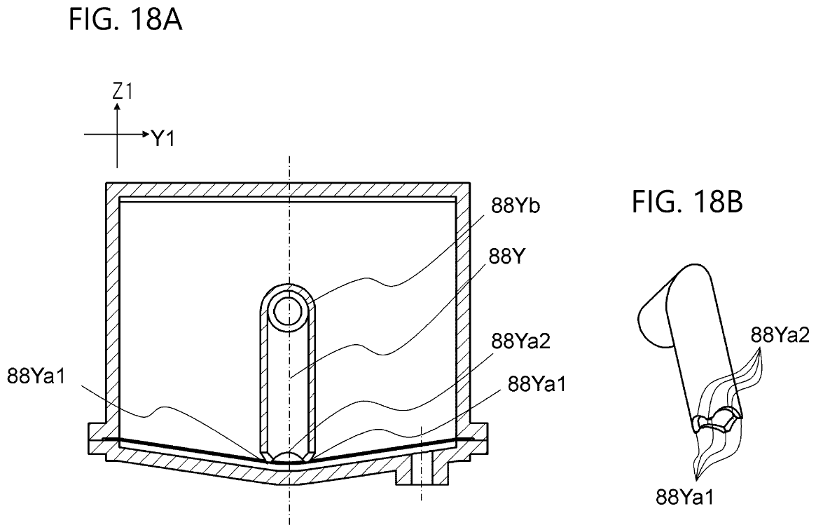

In the first embodiment, the inlet of the discharge pipe was described as having a V-shape, but any other shape may be used as long as it has a contact portion and a gap portion. For example, a U-shape as shown in FIGS. 16A and 16B may be used. FIG. 16A is a cross-sectional view of another embodiment of the toner cartridge, and FIG. 16B is a perspective view of the discharge pipe. Alternatively, a checkmark-like shape as shown in FIGS. 17A and 17B may be used. FIG. 17A is a cross-sectional view of another embodiment of the toner cartridge, and FIG. 17B is a perspective view of the discharge pipe. Furthermore, a shape with four contact portions and four gap portions as shown in FIGS. 18A and 18B may also be used. FIG. 18A is a cross-sectional view of a toner cartridge according to another embodiment, and FIG. 18B is a perspective view of the discharge pipe.

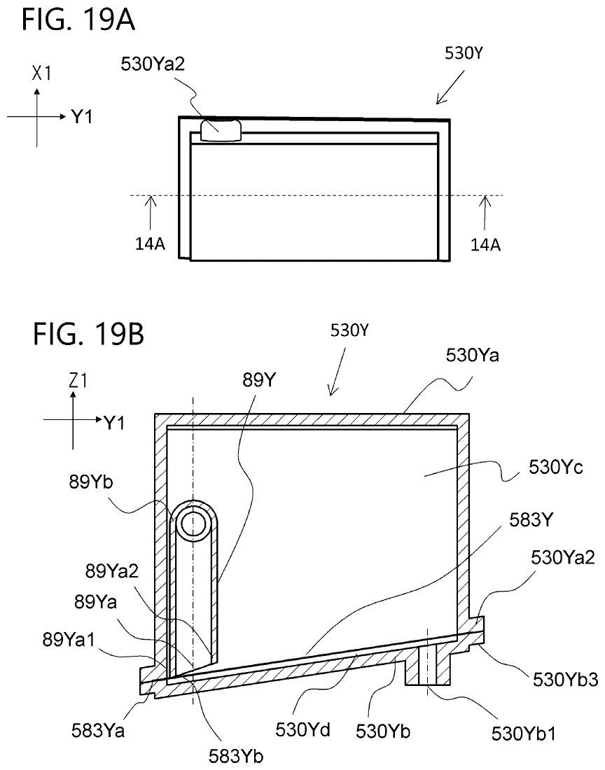

FIG. 19A is a top view showing a toner cartridge according to another embodiment, and FIG. 19B is a cross-sectional view taken along line 14A-14A of FIG. 19A. As shown in FIGS. 19A and 19B, in a configuration where the joining surfaces of the first flange portion 430Yaf and the second flange portion 430Ybf of the first embodiment are not V-shaped but uniformly inclined, the inlet 89Ya of the discharge pipe 89Y is arranged at the end of the container to face the lowest portion. In this configuration as well, the discharge pipe 89Y has a contact portion 89Ya1 that contacts the lowest portion 583Yb of the filter 583Y as the opposing region, and a gap portion 89Ya2 that is arranged to face the lowest portion 583Yb with a gap in the direction of gravity G. The space formed by the filter 583Y and the gap portion 89Ya2 serves as the toner inflow port, and the amount of toner that remains in the toner storage chamber 530Yc without being supplied can be reduced.

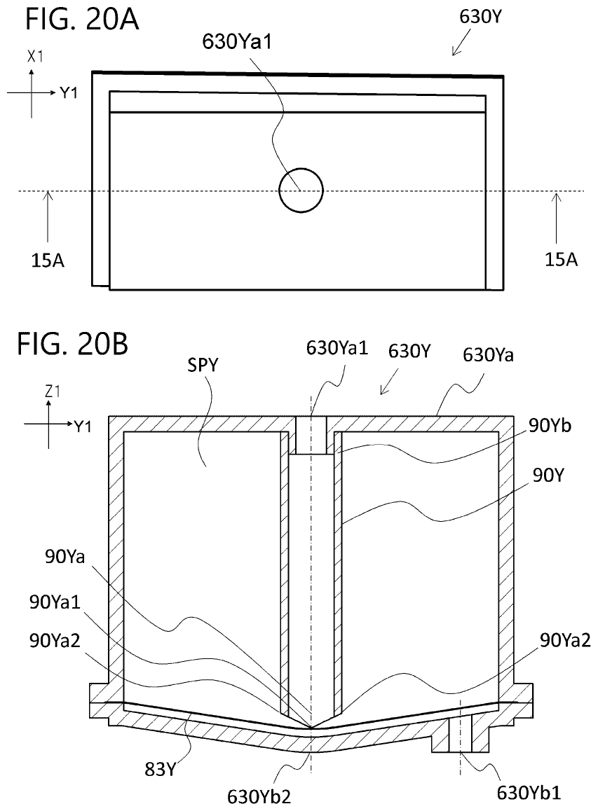

In the first embodiment, the exit of the discharge pipe was described as having an opening at the rear, i.e., upstream in the X1 direction, but other configurations are also possible. FIG. 20A is a top view showing a toner cartridge according to another embodiment, and FIG. 20B is a cross-sectional view showing the toner cartridge taken along line 15A-15A of FIG. 20A. For example, as shown in FIGS. 20A and 20B, a configuration in which the discharge port 630Ya1 is provided on the top surface, i.e., in the Z direction, is also possible. In this configuration, since the conveying path from the inlet 90Ya to the outlet 90Yb of the discharge pipe 90Y does not have a bent portion, pressure loss is reduced, and more efficient toner conveying performance can be expected.

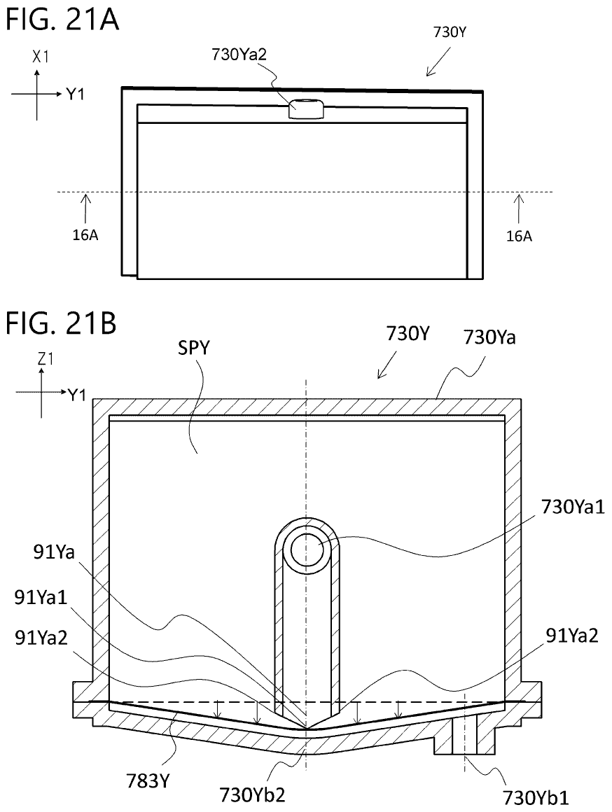

In the first embodiment, it was described that the inlet of the discharge pipe is brought into contact with the lowest portion of the filter, but a configuration in which the inlet of the discharge pipe is arranged so as to interfere with the filter, thereby pushing the filter downward, is also possible. Sheet-like filters may become slackened or wavy when clamped, and by applying tension to the filter in a manner of pushing it down at the inlet of the discharge pipe, it is expected that the filter can be reliably brought into contact and its posture can be stabilized. Furthermore, as shown in FIGS. 21A and 21B, by adopting a configuration in which a filter arranged flat using a flexible filter or the like is made to form a slope by being pressed down by the discharge pipe, an effect of collecting toner with a simpler configuration can be expected. In the pushing-down configuration, it is preferable that the discharge pipe is made of a material with high rigidity such as resin, rather than a material with low rigidity such as paper or rubber. FIG. 21A is a top view showing a toner cartridge according to another embodiment, and FIG. 21B is a cross-sectional view showing the toner cartridge taken along line 16A-16A of FIG. 21A.

As long as the structure has a region where the discharge pipe contacts the filter in the Z1 direction, the effects of the present disclosure can be obtained. That is, in each embodiment, further effects are obtained by providing a slope to the filter or by placing the contact position of the discharge pipe near the central portion in the X direction, but the disclosure is not limited to these.

According to the present disclosure, a preferred embodiment of a cartridge for storing toner used in an image forming apparatus and provided with a filter can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-158000, filed Sep. 12, 2024, which is hereby incorporated by reference herein in its entirety.

What is claimed is:

1. A cartridge configured to be attachable to an apparatus body of an image forming apparatus and to store toner, comprising:
a frame that forms an internal space, the frame having a chamber opening that allows toner to move from an inside to outside of the cartridge and an air chamber opening that allows air to move from the outside to the inside of the cartridge;
a filter that partitions the internal space into an air chamber that receives air via the air chamber opening and a toner storage chamber that stores toner, the filter being fixed to the frame and allowing passage of air while restricting passage of the toner; and
a pipe disposed inside the toner storage chamber, the pipe having a first opening that receives toner stored in the toner storage chamber and a second opening connected to the chamber opening, the pipe allowing toner to pass from the first opening to the second opening, wherein
when the cartridge is in an attachment posture for attachment to the image forming apparatus, the air chamber is provided below the toner storage chamber in the direction of gravity, and
an end surface forming the first opening of the pipe has a first region that contacts the filter positioned below the pipe and a second region that does not contact the filter.

2. The cartridge according to claim 1, wherein
the cartridge has a shape with a long side direction and a short side direction in a horizontal cross-section perpendicular to the direction of gravity,
when the direction of gravity when the cartridge is in the attachment posture is defined as a first direction, the long side direction is defined as a second direction, and the short side direction is defined as a third direction,
when viewed from the third direction, the filter has a first inclined portion that slopes downward from one end in the second direction toward a central portion and a second inclined portion that slopes upward from the central portion toward the other end, and
the first opening of the pipe is open toward a region facing the central portion of the filter.

3. The cartridge according to claim 2, wherein
in a cross-section perpendicular to the short side direction, the first opening of the pipe has a structure in which a central portion in the second direction protrudes more than a peripheral portion, the central portion of the pipe contacts the filter, and the peripheral portion of the pipe has a gap with respect to the filter.

4. The cartridge according to claim 2, wherein
when viewed from the third direction, the filter has an intermediate surface that is disposed between the first inclined portion and the second inclined portion and is not inclined, and the first opening of the pipe faces the intermediate surface.

5. The cartridge according to claim 1, wherein
the chamber opening is provided at a position facing the image forming apparatus when the cartridge is in the attachment posture, and
the toner stored in the toner storage chamber is movable from the toner storage chamber to the image forming apparatus via the pipe.

6. The cartridge according to claim 5, wherein
the toner storage chamber has a seal member provided at a region where the chamber opening is connected to an intake port for the toner, provided in the image forming apparatus.

7. The cartridge according to claim 1, wherein
the air chamber opening of the air chamber is connected to a discharge port for air from an external pump unit when the cartridge is in the attachment posture, and the air is movable from the air chamber to the toner storage chamber via the filter.

8. The cartridge according to claim 1, wherein
the cartridge is constituted by a first frame that forms the toner storage chamber and a second frame that forms the air chamber, the first frame and the second frame being joined together with the filter sandwiched therebetween.

9. The cartridge according to claim 8, wherein
the first frame and the second frame each have a flange portion that sandwiches the filter.
